(19) United States
(12) Patent Application Publication
(10) Pub. No.: US 2025/0119752 A1
(43) Pub. Date: Apr. 10, 2025

(54) AUDIO ACCESS POINT TRANSCEIVER SUPPORTING ADVANCED WIRELESS PAIRING INTERFACES, CLOCK SYNCHRONIZATION, AND DOCKING DETECTION

(71) Applicant: Shure Acquisition Holdings, Inc., Niles, IL (US)

(72) Inventors: Doug DAUBE, Des Plaines, IL (US); Eric JOHNSON, Niles, IL (US); James PESSIN, Forest Park, IL (US)

(21) Appl. No.: 18/909,388

(22) Filed: Oct. 8, 2024

Related U.S. Application Data
(60) Provisional application No. 63/589,223, filed on Oct. 10, 2023.

(51) Int. Cl. H04W 12/50; G06F 1/12; G06F 1/16; H04W 12/03

(52) U.S. Cl. CPC H04W 12/50; G06F 1/12; G06F 1/1632; H04W 12/03

(57) ABSTRACT

An example audio access point transceiver configured to send and receive encrypted wireless audio signals to and from audio capture devices and distribute audio signal data to an audio processing network is provided. The example audio access point transceiver includes a wireless control communication interface, a wireless audio communication interface, and a wired audio communication interface. The wireless control communication interface may be configured to perform a first pairing validation operation that includes determining a wireless audio communication profile, enabling the transmission and receipt of encrypted wireless audio control signals. The wireless audio communication interface may be configured to perform a second pairing validation operation including a channel assignment operation enabling the transmission and receipt of encrypted wireless audio signals to and from audio capture devices. The wired audio communication interface may enable the distribution of audio signal data to the audio processing network.

### CROSS-REFERENCE TO RELATED APPLICATIONS

This application claims the benefit of U.S. Provisional Patent Application No. 63/589,223, filed Oct. 10, 2023, the entire contents of which are hereby incorporated by reference in its entirety.

### TECHNOLOGICAL FIELD

Embodiments of the present disclosure relate generally to an audio access point transceiver, and more particularly, to an audio access point transceiver configured to support advanced wireless pairing interfaces, clock synchronization, and docking detection.

### BACKGROUND

Various audio capture devices maybe employed to capture audio signals by one or more acoustic sources in an acoustic environment. Coordination of the audio capture devices and interface with an audio processing network may be facilitated by an audio access point transceiver. In addition, various audio access point transceivers may be utilized to increase the coverage of wired and wireless audio capture.

### BRIEF SUMMARY

Various embodiments are directed to an example audio access point transceiver, an example audio capture device docking station, and various methods related to the capture of audio signals by one or more audio capture devices. These characteristics as well as additional features, functions, and details of various embodiments are described below. The claims set forth herein further serve as a summary of this disclosure.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example schematic diagram of an example audio capture system comprising an audio access point transceiver in accordance with an example embodiment of the present disclosure.

FIG. 2 illustrates a system level diagram of an example audio capture system including an example audio access point transceiver in accordance with an example embodiment of the present disclosure.

FIG. 3 illustrates an example audio access point transceiver in accordance with an example embodiment of the present disclosure.

FIG. 4 illustrates an example schematic block diagram of an example audio capture system comprising an example audio access point transceiver in accordance with an example embodiment of the present disclosure.

FIG. 5 illustrates a schematic block diagram of example components of a controller in accordance with an example embodiment of the present disclosure.

FIG. 6 illustrates an example flow diagram depicting an example advanced dual pairing validation operation process in accordance with an example embodiment of the present disclosure.

FIG. 7 illustrates an example flow diagram depicting a clock synchronization protocol in accordance with an example embodiment of the present disclosure.

FIG. 8 illustrates an example audio access point transceiver comprising example dockable audio capture devices in accordance with an example embodiment of the present disclosure.

FIG. 9 illustrates an example flow diagram depicting an access point type identification process performed in association with a dockable audio capture device in accordance with an example embodiment of the present disclosure.

FIG. 10 depicts an example audio capture device docking station comprising dockable audio capture devices configured in accordance with an example embodiment of the present disclosure.

FIG. 11 illustrates an example audio capture device docking station configured to produce a docking type indication signal in accordance with an example embodiment of the present disclosure.

FIG. 12 depicts an example schematic block diagram of an example audio capture docking station configured in accordance with an example embodiment of the present disclosure.

FIG. 13 depicts an example circuit diagram of example docking type definition circuitry within an electrical connector of a docking port of an example audio capture docking station in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

Various example embodiments address technical problems associated with receiving audio signals from one or more audio capture devices positioned in an acoustic environment and transmitting the audio signals to an audio processing network. This is a highly complex task as audio capture devices may be configured to communicate via numerous wired and wireless communication protocols, may require varying degrees of encryption and identity validation, and may require frequency band or channel allocation to reduce interference, improve audio quality, and optimize communication efficiency. In less desirable systems, these important operations are tasked to a myriad of different devices that are strung together in ad hoc networks. Unfortunately, such ad hoc networks can raise performance issues when deployed in audio processing networks because such networks require extremely low communication latency as audio signal lag or delay is highly perceptible to listeners in acoustic environments.

An acoustic environment as discussed herein refers to any environment in which the capture of audio signals is desired, such as a lecture hall, concert venue, sports arena, stadium, meeting room, or any other similar audio environment. Such acoustic environments can be interferer laden and highly dynamic as audio capture devices are introduced and removed with great frequency. Audio capture devices include wired and/or wireless transducers configured to capture and transmit audio signals from within the acoustic environment.

Audio signals captured by audio capture devices may be linked or paired to an audio access point transceiver to facilitate transmission of the audio signals to an audio processing network. An audio processing network may perform various operations on the audio signals. For example, the audio signals may be transmitted to a digital signal processor (DSP) configured to perform various operations to filter, clean, extract features, and/or otherwise process the audio signals. The audio processing network may route the audio signals to one or more audio output devices such as a speaker, headphones, headset, and/or an in-ear monitor device. The audio processing network may also be electronically connected to a recording or other storage device and be configured to record and/or store the audio signal from one or more audio channels.

To receive audio signals from wireless audio capture devices that communicate using differing protocols (e.g., Bluetooth® registered by Bluetooth SIG, Inc., digital enhanced cordless telecommunications protocol, etc.), an audio access point transceiver configured according to embodiments herein described supports a dual pairing validation operation including a first pairing validation operation on a first wireless control communication interface and a second pairing validation operation on a second wireless audio communication interface. A first pairing validation operation may include establishing a communication connection in compliance with a first wireless communication protocol (e.g., Bluetooth®). Establishing a connection via the wireless control communication interface by a first pairing validation operation enables the audio access point transceiver to determine a wireless audio communication profile associated with one or more audio capture devices. In some embodiments, the first pairing validation operation may enable the audio access point transceiver to detect the proximity of one or more supported audio capture devices in relation to the audio access point transceiver and in relation to other supported audio capture devices.

A number of desirable benefits may be realized by detecting the proximity of one or more supported audio capture devices. For example, proximity detection may enable an audio access point transceiver to detect supported audio capture devices moving into and out of a radio frequency communication range of the audio access point transceiver. In response to the entry of a supported audio capture device into the frequency communication range (e.g., a Bluetooth® frequency communication range), an audio access point transceiver may automatically pair and assign an audio channel frequency or frequency band to the supported audio capture device. Without executing the first pairing validation operation and establishing communication over the first wireless communication interface, the audio access point transceiver may be unable to detect entry of a supported audio captured device into an acoustic environment.

The dual pairing validation operation referenced above further includes a second pairing validation operation executed on a second wireless audio communication interface. The second pairing validation operation establishes communication with a wireless control device in compliance with a second wireless communication protocol (e.g., a digital enhanced cordless telecommunications or “DECT” protocol) enabling the audio access point transceiver to perform audio channel frequency allocation. To transmit audio signals wirelessly, an audio capture device is configured or directed by the audio access point transceiver to transmit the audio signal at a transmission frequency and the audio access point transceiver configures itself to receive the audio signal by configuring a receiving radio to match the transmission frequency.

An audio capture device may be limited to a specific range or band of transmission frequencies. In addition, some transmission frequencies may be occupied by other audio capture devices and/or other devices in the surrounding environment. The audio access point transceiver of the present disclosure may employ an audio channel frequency allocation algorithm to dynamically assign audio channel frequencies or frequency bands to audio capture devices, enabling the transmission and receipt of encrypted wireless audio signals via the wireless audio communication interface. For example, an audio access point transceiver may assign an audio channel frequency based on one or more device status properties of the audio capture device. An audio access point may allocate an audio channel frequency based on a historical utilization of the available audio channel frequencies.

A number of desirable benefits may be realized by utilizing an audio access point transceiver to automatically assign audio channel frequencies. For example, utilizing an audio channel frequency allocation algorithm the audio access point transceiver may strategically assign audio channel frequencies or frequency bands to reduce interference in the acoustic environment. The audio access point transceiver may further assign audio channel frequencies based on device status properties, such as the audio capture device type, role, or settings. In addition, accessing a wireless audio communication profile via the first wireless communication protocol may enable preset preferences, such as audio capture device priorities and fixed channel assignments to be considered in the automatic assignment of audio channel frequencies. Without an audio access point transceiver configured to assign audio channel frequencies according to an audio channel frequency allocation algorithm, significant manual user involvement may be necessary.

In various embodiments, audio access point transceivers as discussed herein operate to synchronize clocks of audio capture devices and other devices within an acoustic environment. Clock synchronization can be important to efficiently coordinate audio signals received from a plurality of audio capture devices and can serve an important role in reducing overall communication latency. For example, audio signals received at an audio processing network are preferably synchronized before amplification, storage, mixing, and/or playback for an optimal audio experience.

In some examples, wired networked devices, such as wired devices communicating via an audio processing network including an audio access point transceiver, wired audio capture devices, and other wired devices, may operate on a synchronized network clock. However, wireless devices, such as audio capture devices utilizing the digital enhanced cordless telecommunications protocol (DECT) and/or other wireless client devices connected to the audio access point transceiver, may also require clock synchronization by other means.

In some embodiments, an audio access point transceiver may include a clock synchronization protocol enabling clock synchronization of various audio capture devices, such as DECT audio capture devices and/or Bluetooth® audio capture devices. For example, a clock synchronization protocol as disclosed herein may cause a master device (e.g., an audio access point transceiver) to transmit a periodic synchronization initiation transmission via a wireless audio communication interface. In some embodiments, the periodic synchronization transmission may comprise timestamp data enabling synchronization of audio signal data transmitted from a plurality of audio capture devices.

A number of desirable benefits may be realized by performing clock synchronization of audio capture devices, particularly wireless audio capture devices, in an acoustic environment. Clock synchronization before amplification, storage, mixing, and/or playback may reduce latency associated with an audio capture system. In undesirable audio systems, an audio channel frequency band of the wireless audio communication interface may be dedicated to clock synchronization. Dedicating an audio channel frequency band to clock synchronization reduces the number of available audio channel frequency bands that are available for transmitting and receiving audio signals. In contrast, various embodiments discussed herein use a wireless control communication interface to execute a clock synchronization protocol and thereby optimize the number of audio channel frequency bands that are available for audio signal communications.

Various example embodiments additionally address technical problems associated with docking an audio capture device at a docking port. Various devices within an audio capture system may utilize a docking port to dock and charge an audio capture device, particularly wireless audio capture devices. Such docking ports may be supported or embodied by docking devices having various form factors including, without limitation, an audio access point transceiver or an audio capture device docking station.

In some embodiments, a docking port includes docking type definition circuitry configured to produce a docking type indication signal when the docking end of an audio capture device (i.e., a dockable audio capture device) is received into the docking port. Recognizing the docking type of the docking port may enable a dockable audio capture device to perform different operations when docked in a docking port of a particular type. In one example, docking an audio capture device in a docking port of an audio access point transceiver or connected remote audio capture device docking station may cause a triggering event, which in one example might initiate an audio channel frequency allocation. In another example in which the docking port is supported by a network device (e.g., an audio access point transceiver) that is configured itself to support wired or wireless communication with an audio processing network, the detection of the docking port type by the dockable audio capture device may cause the audio capture device to disable its wireless communication radio and thereby improve its charging efficiency.

The electrical connector of the docking port may comprise one or more circuit definition pins configured to produce a docking type indication signal. The dockable audio capture device may utilize the docking type indication signal generated by the one or more circuit definition pins within the electrical connector to indicate the docking station type. The docking port is also configured to indicate a power state to a dockable audio capture device.

A number of desirable benefits may be realized from detecting a docking type and the power state of the docking station at a dockable audio capture device. For example, the docking station may initiate one or more audio capture device actions, such as disabling a radio frequency transmitter on the audio capture device or powering off the audio capture device in an instance in which the docking station is in a power off state. Such audio capture device actions may prolong the battery life of a dockable audio capture device.

In undesirable example systems, an audio capture device may be docked in a docking station that is in a power off state unbeknownst to a user. The docked audio capture device may continue to operate in a number of power-consuming ways including, for example, by continuing wireless communication operations using its wireless communication radio. Unfortunately, as the docking station is in a power off state, it is not operating to charge the docked audio capture device thereby leaving the docked audio capture device to rapidly dissipate its charge. This creates an undesirable user experience in that a user has docked an audio capture device into a docking station expecting to charge the audio capture device only to return and find that the audio capture device has completely dissipated its charge.

Various embodiments discussed herein provide numerous functionalities directed to improved capture and playback of audio signal data and execution of command and control data from various wired and wireless devices within an acoustic environment. For example, the receipt of audio signals over wireless audio frequency bands may be coordinated according to an automated channel allocation algorithm. An automated channel allocation algorithm reduces interference across audio capture devices and limits the need of manual configuration particularly when managing highly dynamic acoustic environments in which audio capture devices are introduced and removed with great frequency. Command and control data may be received over various wireless and wired interfaces to define the architecture and operation of the audio capture system, coordinating the flow of audio signal data through the audio capture system.

Dockable audio capture devices that are docked in a variety of docking stations within an acoustic environment may be configured to exhibit improved behavior based on a recognition of a docking port or a particular docking port type. Use of access point transceivers as discussed herein, which may or may not be deployed as docking stations, enable audio capture devices to be promptly detected, authenticated, and efficiently synchronized across the audio capture system. Each of the above-described functions improves the capture of audio signals within an acoustic environment, optimizes the coordinated entry of audio signal data into an audio processing network, and improves the overall operation of an audio capture system in an acoustic environment.

In some embodiments, the myriad of improved operations discussed above may be executed by a single audio access point transceiver. This improved single device embodiment stands in sharp contrast to undesirable systems that employ a myriad of devices strung together in ad hoc networks. An example single device audio access point transceiver as discussed herein reduces the physical space needed for deployment and eliminates the undue cabling needed in less desirable multi-device systems. Single device audio access point transceiver deployments also provide more efficient system setup and maintenance while also improving overall aesthetics of the audio capture system.

### Audio Capture System Details

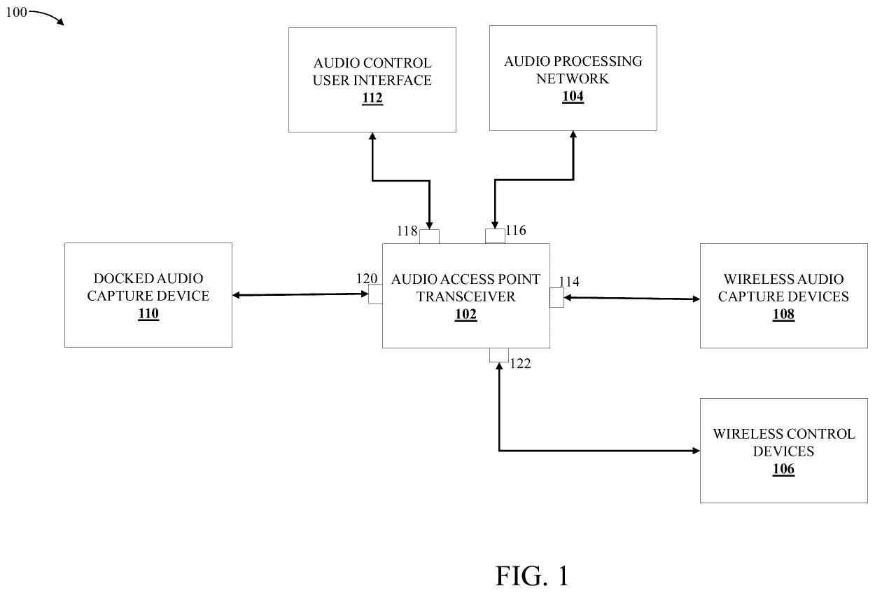

Referring now to FIG. 1, an example audio capture system 100 is provided. An audio capture system 100 coordinates the receipt of audio signals and command and control data related to the audio capture system 100 at an audio access point transceiver 102. As depicted in FIG. 1, the example audio access point transceiver 102 comprises a wireless audio communication interface 114, a wired audio communication interface 116, a wired control communication interface 118, a docking port 120, and a wireless control communication interface 122. The depicted wired audio communication interface 116 is electrically connected to an audio processing network 104 and configured to transmit audio signal data to the audio processing network 104.

The wireless audio communication interface 114 is communicatively connected to one or more wireless audio capture devices 108 and configured to receive an audio signal at an audio channel frequency. The depicted one or more wireless control devices 106 are communicatively connected to the wireless control communication interface 122. A dockable audio capture device 110 is electrically connected to the docking port and an audio control user interface 112 is electrically connected to the wired control communication interface 118.

The depicted audio capture system 100 includes an audio access point transceiver 102. An audio access point transceiver 102 is any device comprising a wireless audio communication interface 114 configured to receive audio signals from one or more wireless audio capture devices 108; a wireless control communication interface 122 configured to receive command and control data from one or more wireless control devices 106; and a wired audio communication interface 116 facilitating the transmission of audio signal data to an audio processing network 104.

An audio access point transceiver 102 is further configured to support a dual pairing validation operation that is compliant with a first wireless communication protocol at a wireless control communication interface (e.g., wireless control communication interface 122) and a second wireless communication protocol at a wireless audio communication interface 114. Said differently, audio access point transceiver 102 is configured to communicate with wireless audio capture devices (not shown) having wireless radios that are configured to communicate via at least two wireless communication protocols. The depicted audio access point transceiver 102 performs these disparate communications via its wireless audio communication interface 114 and wireless control communication interface 122, respectively.

The first pairing validation operation includes any action or sequences of actions required by the first wireless communication protocol to enable sending and receiving of encrypted wireless audio control signals across the wireless control communication interface 122. For example, the first pairing validation operation may include authentication of a wireless control device 106 and other exchanges of data to enable transmission of encrypted wireless audio control signals. In some embodiments, the wireless communication protocol supported by the wireless control communication interface 122 may be a Bluetooth® protocol including, without limitation, a Bluetooth Low Energy or BLE protocol.

The second pairing validation operation includes any action or sequences of actions required by the second wireless communication protocol to enable sending and receiving of encrypted wireless audio signals across the wireless audio communication interface 114. For example, the second pairing validation operation may include authentication of a wireless audio capture device 108 and other exchange of data to enable transmission of encrypted wireless audio signals. In some embodiments, the wireless communication protocol supported by the wireless audio communication interface 114 may be a DECT protocol.

In some embodiments, the second pairing validation operation performed on the wireless audio communication interface 114 may include a channel assignment operation. To receive an encrypted audio signal from a wireless audio capture device 108, the wireless audio communication interface 114 is configured to tune, select, or otherwise configure its antenna to an audio channel frequency matching the audio channel frequency assigned to wireless audio capture device 108. In an acoustic environment comprising a plurality of wireless audio capture devices 108 and other sources of radio frequency (RF) interference, audio channel frequencies are selected to reduce interference and improve the likelihood that a clear and distinguishable audio signal is received from each wireless audio capture device 108.

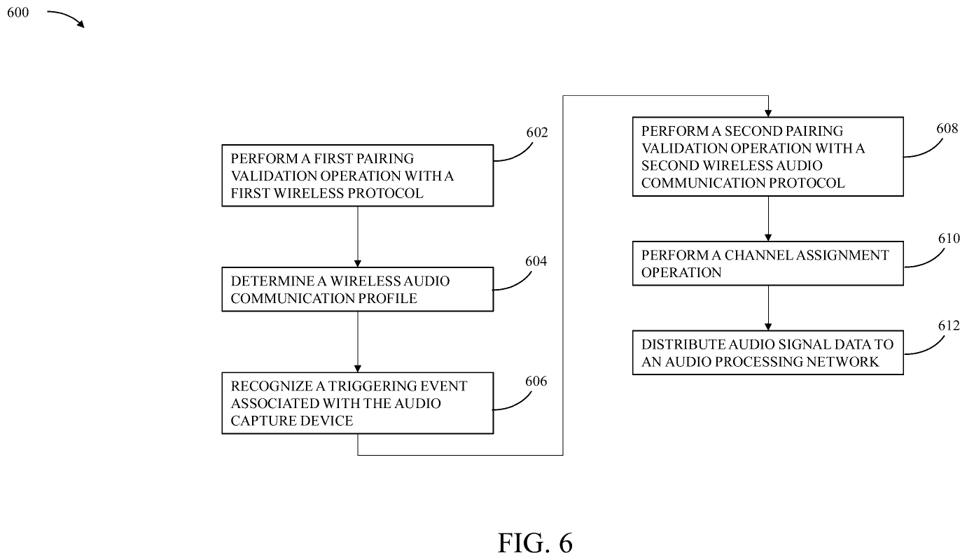

In various embodiments, an audio channel allocation algorithm may be utilized by audio access point transceiver 102 to perform a channel assignment operation. The audio channel allocation algorithm is described further in relation to FIG. 6 below.

The example audio access point transceiver 102 depicted in FIG. 1 is configured to communicate with one or more wireless audio capture devices 108. A wireless audio capture device 108 is any apparatus or device comprising one or more transducers configured to receive sound waves, convert the sound waves into an electrical signal, and transmit a digital representation of the electrical signal (e.g., audio signal) in accordance with a wireless communication protocol. The wireless audio capture device 108 may be configured to transmit the audio signal at a defined frequency or within a defined frequency band, for example, an audio channel frequency determined by the audio access point transceiver. Wireless communication protocols utilized by a wireless audio capture device 108 may include but are not limited to DECT and Bluetooth®.

The depicted audio access point transceiver 102 also includes a wireless control communication interface 122. A wireless control communication interface 122 comprises any circuitry including a radio enabling the audio access point transceiver 102 to receive command and control data from one or more wireless control devices 106. A wireless control communication interface 122 may comply with a wireless communication protocol. As a non-limiting example, the wireless control communication interface 122 may transmit and receive command and control data in accordance with the Bluetooth® protocol.

A wireless control device 106 is any device comprising a wireless audio communication profile and configured to transmit and receive wireless audio control signals in compliance with a wireless communication protocol, for example, Bluetooth®. Non-limiting examples of wireless control devices 106 may include mobile phones, laptops, tablets, remote controls, and other portable computing devices.

In some embodiments, the audio capture device may comprise a dual radio audio capture device. A dual radio audio capture device is any audio capture device configured to interface with both the wireless audio communication interface 114 and the wireless control communication interface 122. For example, in some embodiments, a dual radio audio capture device may include two wireless radios, one configured to establish a Bluetooth® connection with the audio access point transceiver 102 and one configured to establish a DECT connection with the audio access point transceiver 102. In such an example, both the wireless audio capture device 108 and the wireless control device 106 establish a connection with the wireless audio communication interface 114 and the wireless control communication interface 122, respectively.

A wireless audio communication profile is a set of settings, parameters, and data, including authentication data associated with a user profile configured to control one or more properties of the audio capture system 100 and/or an associated wireless audio capture devices 108 specific to the user profile or account. For example, the wireless audio communication profile may include a list of supported audio capture devices, device specifications, unique identifiers, encryption information and keys, and other data related to the audio access point transceiver 102 and connected devices. In an embodiment in which the wireless control device 106 is associated with a specific wireless audio capture device 108, the wireless audio communication profile may include specific parameters of the wireless audio capture device 108, including supported frequencies, the type of the wireless audio capture device 108, preferred audio channel frequencies, the proximity of the wireless audio capture device 108, an identifier of the wireless audio capture device 108, and so on.

In some embodiments, a wireless audio communication profile may include channel allocation settings. Channel allocation settings include any settings, parameters, and/or data specifying rules or parameters related to the allocation of audio channel frequencies. For example, the channel allocation settings may include identifying information of preferred wireless audio capture devices 108. Preferred wireless audio capture devices 108 may override an already paired wireless audio capture device 108 in an instance in which the preferred wireless audio capture device 108 and the already paired wireless audio capture device 108 are both enabled. For example, in a classroom setting, a teacher's personal/assigned wireless audio capture device 108 may be designated as a preferred wireless audio capture device 108. In some instances, a second microphone may be introduced into the room as a second wireless audio capture device 108 on the same channel, perhaps, for example, a student wireless audio capture device 108 for asking questions. In such an instance, the teacher's personal/assigned wireless audio capture device 108, designated as a preferred wireless audio capture device 108, may override the student wireless audio capture device 108.

Channel allocation settings may include fixed channel or lock channel settings in relation to an audio access point transceiver 102. Fixed channel settings may indicate the assignment of one or more wireless audio capture devices 108 to a specified audio channel frequency. Similarly, locked channel settings may indicate one or more audio channel frequencies that are not available to a wireless audio capture device 108. In some embodiments, wireless audio capture devices 108 without a specified fixed channel setting may utilize an available audio channel frequency that has not been locked or fixed for another wireless audio capture device 108.

The depicted example audio access point transceiver 102 includes a wired audio communication interface 116. The wired audio communication interface 116 is any circuitry configured to facilitate the transmission of digital audio signal data to an audio processing network 104 in accordance with a wired audio communication protocol. An audio access point transceiver 102 may be configured to receive audio signals from one or more wired audio capture devices, dockable audio capture devices 110, wireless audio capture devices 108, or any other connected audio capture device. The audio signals may be converted or otherwise transmitted as digital audio signal data to the audio processing network 104 for amplification, storage, playback, or other similar purposes.

Audio signal data is transmitted from the depicted audio access point transceiver 102 to an audio processing network 104 via the wired audio communication interface 116. The audio processing network 104 is any device or set of devices configured to connect to or embody a digital network that is configured for receiving, processing, and/or distributing digital audio signal data. In some embodiments, the audio processing network 104 may comprise a DSP or other similar processing elements configured to perform various operations on the digital audio signal data, such as applying various audio filters, cleaning or denoising the digital audio signal data, removing echo or reverberation signals, extracting features indicative of the digital audio signal data, utilizing algorithms including artificial intelligence algorithms to identify audio features, and/or otherwise processing the audio signal data. An audio processing network 104 may be further configured to transmit the digital audio signal data on various audio channels to be output, for example, on a speaker system, to be stored or otherwise saved, and/or to be transmitted for remote playback. Non-limiting examples of an audio processing network 104 device may include an audio network interface, such as a Shure ANI4OUT audio network interface.

The depicted audio access point transceiver 102 further includes a wired control communication interface 118 configured to transmit and receive audio system control data associated with an audio control user interface 112. The wired control communication interface 118 is any circuitry including hardware and/or software configured to facilitate the transmission of digital control data related to the audio capture system 100 in accordance with a wired communication protocol, for example an Ethernet protocol.

The wired control communication interface 118 enables reception of audio system control data from one or more audio control user interfaces 112. An audio control user interface 112 is any software, hardware, or combination thereof providing means to receive audio system control data associated with an audio capture system 100 from a connected user device. Audio system control data may include various parameters related to the overall setup of the audio capture system 100. For example, an audio control user interface 112 may provide audio system control data establishing the digital communication connections between interconnected devices associated with the audio access point transceiver 102 and the audio processing network 104. Audio system control data may include configuration parameters related to the position and orientation of one or more audio capture devices associated with the audio access point transceiver 102. For example, audio system control data provided by an audio control user interface 112 may be utilized to adjust the polar patterns and or directionality of the coverage lobes of an audio capture device (e.g., a ceiling array microphone); control microphone gain; control microphone equalization and filtering; manage radio frequency output power; access and control microphone mute status and microphone battery status; etc. In some embodiments, the audio control user interface 112 may comprise audio control and configuration software, such as the Shure Designer™ system configuration software.

The depicted audio capture system 100 includes a docking port 120 configured to receive and electronically communicate with one or more dockable audio capture devices 110. A dockable audio capture device 110 is any wired or wireless audio capture device (e.g., one or more transducers configured to capture sound waves from an acoustic environment and convert the captured sound waves to an electrical signal for transmission as an audio signal) designed with a docking end, such that the docking end is configured to be received within a docking port 120 of an audio access point transceiver 102. A dockable audio capture device 110 is further electrically coupled to the audio access point transceiver 102 via the docking port 120 and/or an electrical connector.

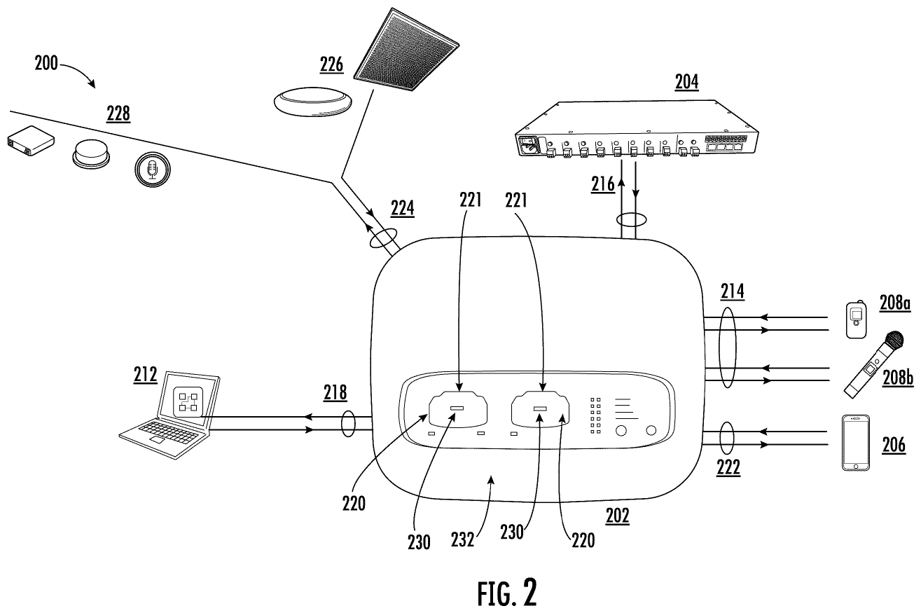

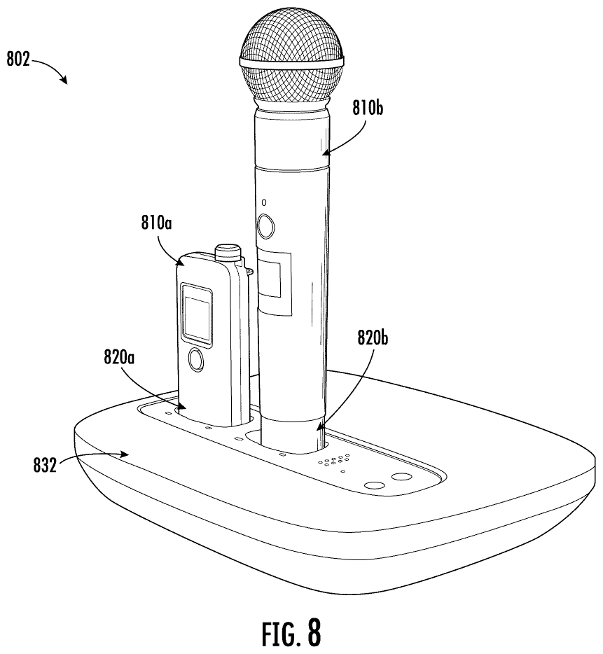

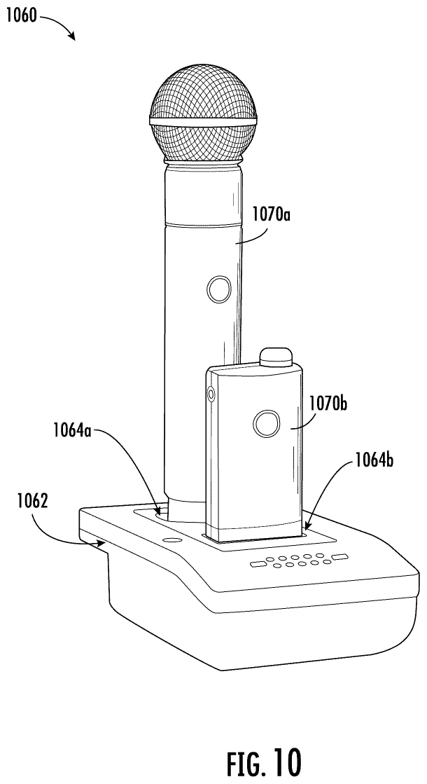

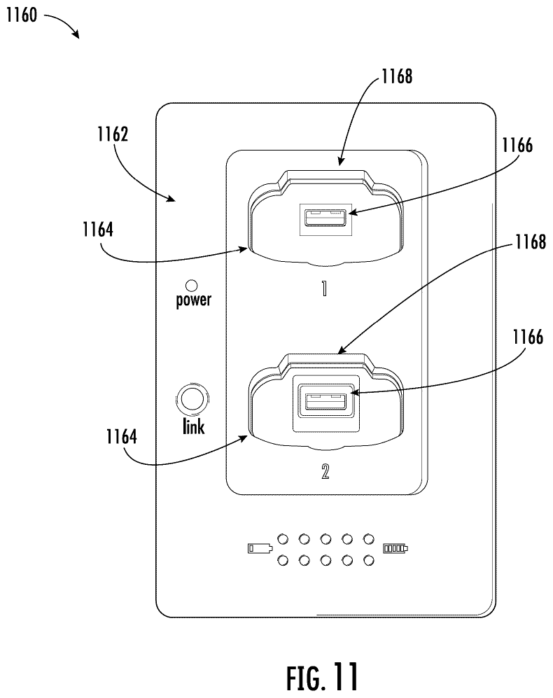

A docking port 120 is any port, slot, or other opening configured to receive the docking end of a dockable audio capture device 110. A docking port 120 may be shaped to slideably receive the docking end of one or more dockable audio capture devices 110 in a particular docking orientation that encourages a robust electrical connection. In some embodiments, the docking port 120 may be shaped to reciprocally match the docking end of a dockable audio capture device 110 such that the dockable audio capture device 110 is received in a docking orientation. Example docking ports 120 that are configured to receive a plurality of dockable audio capture devices 110 are further depicted in FIG. 2, FIG. 8, FIG. 10, and FIG. 11.

A docking port 120 may include an electrical connector (e.g., electrical connector 221 as depicted in FIG. 2) configured to charge or otherwise provide power to a dockable audio capture device 110, enable the transmission and reception of communication data to and from the audio access point transceiver 102, and otherwise enable electronic interactions between the dockable audio capture device 110 and the audio access point transceiver 102. In some embodiments, the electrical connector may be aligned such that the dockable audio capture device 110 slideably connects with the electrical connector in an instance in which the docking end of the dockable audio capture device 110 is received into the docking port 120. In some embodiments, the electrical connector may comprise a universal serial bus (USB) connector.

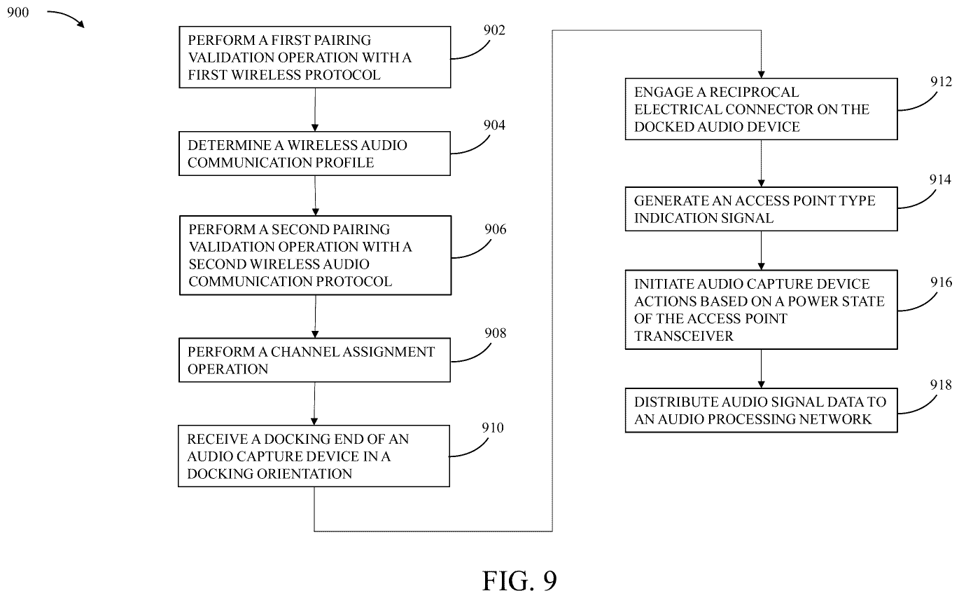

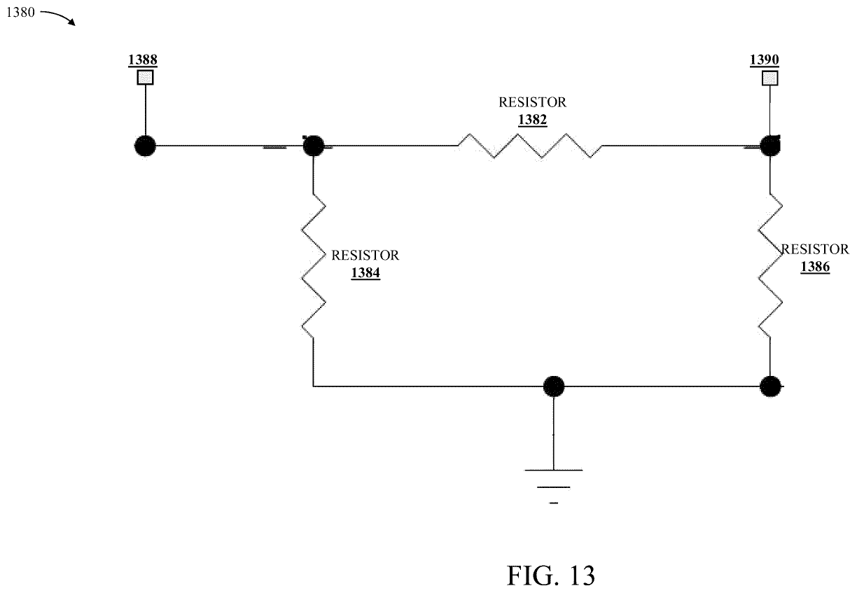

In some embodiments, the docking port 120 may be configured to produce an access point type and/or a docking type indication signal indicating to the dockable audio capture device 110 the type of the docking port 120 and the associated audio access point transceiver 102. The docking type may be indicated to the dockable audio capture device 110 in an instance in which the docking port 120 and/or the audio access point transceiver 102 is in a power off state. The docking type indication process is discussed further in relation to FIG. 9. An example circuit diagram of an electrical connector enabling indication of a docking type and/or access point type is described in relation to FIG. 13.

FIG. 2 depicts a system-level view of an example audio capture system 200. An audio capture system 200 coordinates the receipt and distribution of audio signals and command and control data from various sources at an audio access point transceiver 102. The depicted audio capture system 200 includes an audio access point transceiver 202 having a wireless audio communication interface 214 configured to receive wireless audio signals from one or more wireless audio capture devices 208a-208b. The wireless audio capture devices 208a-208b may include various microphones, such as a body back microphone, a handheld microphone, a lavalier microphone, a fixed microphone, an array microphone, gooseneck microphones, or any other wireless audio capture device configured to capture and transmit audio signal data in accordance with a wireless communication protocol.

The depicted audio access point transceiver 202 also includes a wireless control communication interface 222 configured to receive wireless audio control signals from one or more wireless control devices 206. The depicted wireless control devices may include mobile phones, laptops, tablets, remote controls, and other portable computing devices configured to transmit wireless audio control signals to an audio access point transceiver 202.

The example audio access point transceiver 202 includes a wired audio communication interface 216 configured to transmit audio signal data to an audio processing network 204. As described herein, the audio processing network may comprise an audio network interface device (e.g., audio processing network 204) configured to receive audio signal data and command data to distribute the received audio signal data to various audio devices. An audio processing network 204 may further include circuitry or devices to apply various audio filters, clean or denoise the digital audio signal data, extract features indicative of the digital audio signal data, utilize algorithms including artificial intelligence algorithms to identify audio features, and/or otherwise process the audio signal data.

The depicted audio access point transceiver 202 includes a wired control communication interface 218 configured to receive audio system digital control data from an audio control user interface 212, such as a laptop executing audio control and configuration software associated with the audio access point transceiver 202 and connected devices. In some embodiments, the audio control user interface 212 may generate settings, parameters, and other data to configure the placement, orientation, and RF field of one or more audio capture devices. In addition, the audio control user interface 212 may provide connection settings and parameters indicating various connections to be established through the audio capture system 200. In some embodiments, the wired control communication interface 218 may comprise a USB connection configured to receive command and control data from system configuration software, such as the Shure Designer™ system configuration software.

The depicted audio access point transceiver 202 includes docking ports 220 defined by an access point body 232 and comprising electrical connectors 230. The depicted docking port 220 is structured to define a docking cavity having a locating feature 221 as shown. The docking cavity of the docking port 220 is configured to slideably receive the docking end of a dockable audio capture device and the locating feature 221 of the docking cavity is structured to align with a reciprocally structured locking feature defined by the docking end of the dockable audio capture device to ensure that the dockable audio capture device is locked into a docking orientation.

The depicted electrical connector 230 provides an electrical connection to the dockable audio capture device, facilitating the transfer of power and data between the dockable audio capture device and the audio access point transceiver 202. In some embodiments, docking or undocking a wireless audio capture device 108 at a docking port 220 may constitute a triggering event, initiating a channel assignment operation.

The depicted audio access point transceiver 202 includes a wired audio device communication interface 224. The wired audio device communication interface 224 is any circuitry including hardware and/or software configured to exchange digital audio signal data with one or more wired audio capture devices 226 and/or wired audio receipt devices 228 according to a wired communication protocol. As one non-limiting example, the wired audio device communication interface 224 may operate in accordance with a streaming audio/visual protocol such as AES67, real-time transport protocol (RTP), Dante® protocol, etc. The wired audio device communication interface 224 may enable the audio access point transceiver 202 to receive audio signals from one or more wired audio capture devices 226. Wired audio capture devices 226 are any audio transducers configured to generate digital audio signal data in compliance with the wired communication protocol supported by the wired audio device communication interface 224. For example, wired audio capture devices may include array microphones, ceiling microphones, mounted microphones, and other wired audio capture devices.

The wired audio device communication interface 224 may further enable an audio access point transceiver 202 to transmit digital audio signal data to one or more wired audio receipt devices 228. A wired audio receipt device 228 is any wired device configured to receive digital audio signal data complying with the wired communication protocol supported by the wired audio device communication interface 224. For example, a wired audio receipt device 228 may include a DSP, a speaker, a recorder, a network router, or another similar device configured to receive digital audio signal data.

In some embodiments, the wired audio device communication interface 224 and the wired audio communication interface 216 may comprise the same physical connector on the audio access point transceiver 202. For example, a single RJ45 port. Thus, digital audio signal data and digital command data may be transmitted and received through a single physical port.

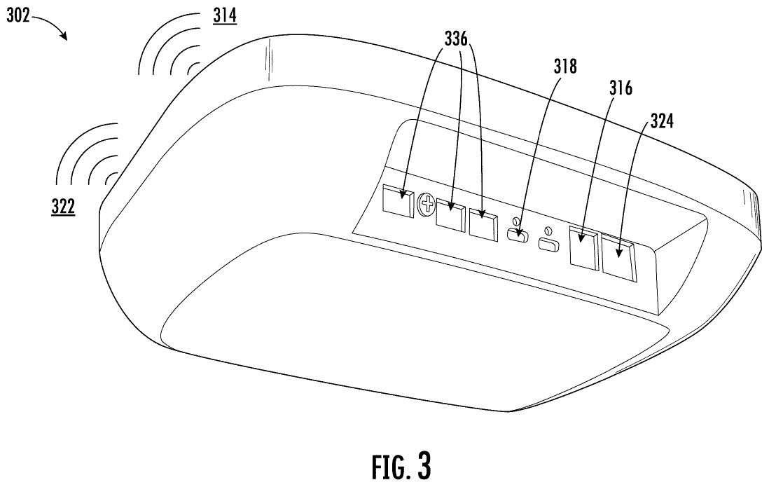

FIG. 3, depicts an example audio access point transceiver 302 structured in accordance with various embodiments. As shown in FIG. 3, the example audio access point transceiver 302 includes a plurality of physical ports and two wireless communication radios to facilitate various wired and wireless interfaces configured to receive and transmit analog audio signals, digital audio, and command and control signals related to the audio capture system. The physical ports include analog audio output interfaces 336, wired control communication interfaces 318, one or more wired audio communication interfaces 316, and one or more wired audio device communication interfaces 324. The wireless communication radios include a wireless audio communication interface 314 and a wireless control communication interface 322.

The depicted audio access point transceiver 302 includes an analog audio output interface 336. The analog audio output interface 336 is any circuitry including hardware and/or software and associated port configured to output analog audio signal data. The depicted analog audio output interface 336 includes analog audio input ports configured to receive analog audio input ports and an analog audio output port configured to output analog audio signal data. In some embodiments, the analog audio output interface 336 may enable an audio access point transceiver 302 to convert digital audio signal data received at the audio access point transceiver into analog audio signal data to be distributed via the analog audio output interface 336. The analog audio output interface 336 may enable transmission of analog audio signal data to various analog devices such as amplifiers, speakers, audio processors, video codecs, and other similar devices.

The example audio access point transceiver 302 depicted in FIG. 3 enables robust communication and close coordination between multiple wired and wireless audio capture devices, wired and wireless control devices, docked audio capture devices, audio control interfaces, and other audio capture system devices with an audio processing network. In contrast to less desirable systems that are comprised of various devices strung together in ad hoc networks, the depicted audio access point transceiver 302 is configured to enable robust communication and close coordination between disparate devices communicating via different protocols having varied levels of encryption in a single device form factor as shown.

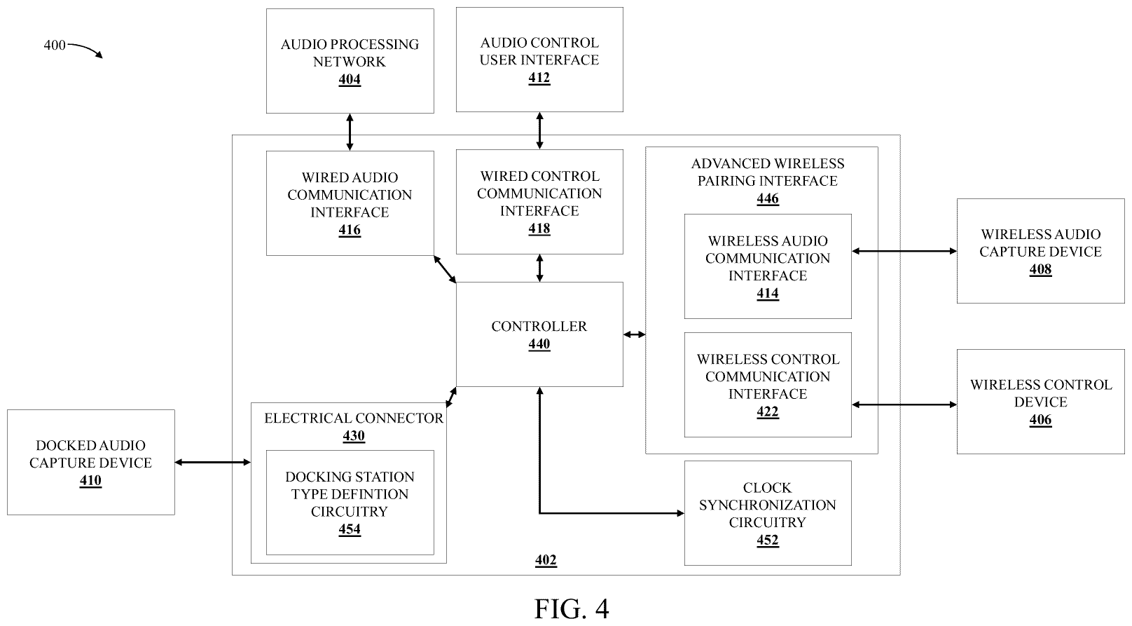

FIG. 4 depicts a schematic block diagram of an example audio capture system 400 structured in accordance with various embodiments. The example audio access point transceiver 402 depicted in FIG. 4 is configured to interface with an audio processing network 404, an audio control user interface 412, a wireless audio capture device 408, a wireless control device 406, and a dockable audio capture device 410. The depicted audio access point transceiver 402 also includes a controller 440 electrically coupled to a wired audio communication interface 416, a wired control communication interface 418, an advanced wireless pairing interface 446 comprising a wireless audio communication interface 414 and a wireless control communication interface 422, clock synchronization circuitry 452, and a docking port 420 including docking type definition circuitry 454.

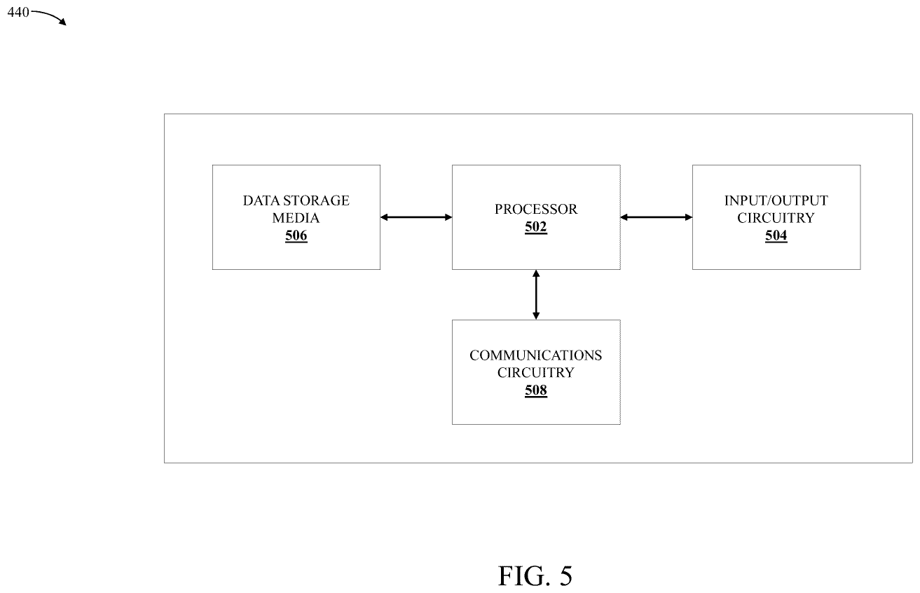

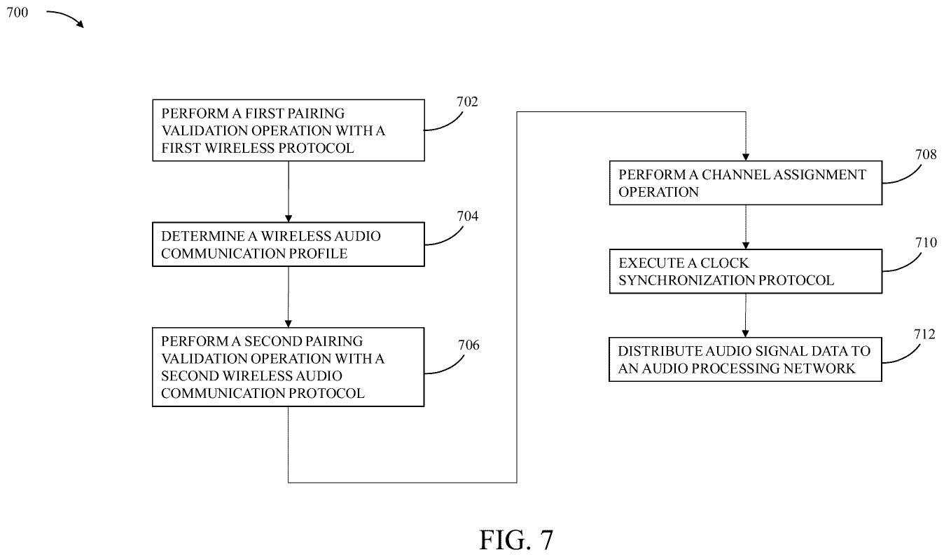

The depicted audio access point transceiver 402 includes a controller 440. The controller 440 is any processor, microcontroller, or other similar computing device configured to operate one or more instructions to execute the functionality described herein. For example, the controller 440 may execute instructions necessary to perform an advanced dual pairing validation operation as described in relation to FIG. 6, the determination of a wireless audio communication profile, a channel assignment operation, actions in support of executing a clock synchronization protocol as described in relation to FIG. 7, actions in support of an access point type identification process performed in association with a dockable audio capture device 410, and other instructions in support of additional functionality. An example schematic block diagram of example components of a controller 440 are depicted in FIG. 5.

The depicted audio access point transceiver 402 also includes an advanced wireless pairing interface 446 including a wireless audio communication interface 414 and a wireless control communication interface 422. An advanced wireless pairing interface 446 is any circuitry comprising hardware and/or software configured to establish a connection with one or more wireless audio capture devices 408 via a wireless control communication interface 422 and establish a connection with one or more wireless control devices 406 via the wireless audio communication interface 414.

As described further in relation to FIG. 6, the controller 440 may utilize the wireless control communication interface 422 to determine a wireless audio communication profile. In an instance in which the wireless control device 406 is associated with a wireless audio capture device 408, the wireless audio communication profile may additionally comprise identification and proximity and/or location data. Proximity and/or location data may enable a controller 440 to determine whether a triggering event has occurred, such as a supported wireless audio capture device 408 entering or exiting the wireless communication proximity of the audio access point transceiver 402.

The depicted controller 440 may utilize a wireless audio communication interface 414 to execute an audio channel frequency allocation using an audio channel frequency allocation algorithm. As described further in relation to FIG. 6, the controller 440 may assign an audio channel frequency or frequency band to a wireless audio capture device 408 based on a historical utilization of the audio channel frequencies, the type and/or status of the wireless audio capture device 408, the availability of audio channel frequencies, and other similar factors.

The depicted audio access point transceiver 402 includes clock synchronization circuitry 452. Clock synchronization circuitry 452 is any circuitry including hardware and/or software configured to enable execution of a clock synchronization protocol providing synchronized clocks across a plurality of audio capture devices, control devices, audio access point transceivers, and/or other wireless and wired devices comprising the audio capture system 400. An example clock synchronization protocol is described further in relation to FIG. 7.

The depicted electrical connector 430 includes docking type definition circuitry 454. Docking type definition circuitry 454 is any circuitry including hardware and/or software configured to generate a docking type indication signal via the electrical connector 430. Docking type definition circuitry 454 includes a plurality of circuit definition pins, such that in an instance in which a dockable audio capture device 410 is electrically coupled to the electrical connector 430, the docking type definition circuitry 454 generates a unique docking type indication signal (e.g., voltage, current, resistance, etc.), indicating to the dockable audio capture device 410, the type of the electrical connector 430, and/or the type of the audio access point transceiver 402. Further, the docking type definition circuitry 454 may indicate the orientation of the connector of the dockable audio capture device 410 relative to the electrical connector 430.

The docking type definition circuitry 454 may indicate the docking type or audio access point transceiver type in an instance in which the docking port 420 and/or audio access point transceiver 402 is disposed in a power-off state. In such an instance, the docking port 420 may initiate one or more audio capture device actions on the dockable audio capture device 410. The access point type identification process is described further in relation to FIG. 9.

The docking type definition circuitry 454 may be integrated in conjunction with the circuitry comprising the electrical connector 430, for example utilizing the sideband use (SBU) pins of a USB connector. An example circuit diagram for example docking type definition circuitry 454 is provided in FIG. 13.

A controller 440 may be embodied by one or more computing systems, such as apparatus 500 shown in FIG. 5. The apparatus of FIG. 5 may be configured to perform the techniques of FIG. 4 as well as other techniques described herein. The apparatus 500 may include processor 502, data storage media 506, input/output circuitry 504, and a communications circuitry 508. Although these components 502-508 are described with respect to functional limitations, it should be understood that the particular implementations necessarily include the use of particular hardware. It should also be understood that certain of these components 502-508 may include similar or common hardware. For example, two sets of circuitries may both leverage use of the same processor, network interface, storage medium, or the like to perform their associated functions, such that duplicate hardware is not required for each set of circuitries.

In some embodiments, the processor 502 (and/or co-processor or any other processing circuitry assisting or otherwise associated with the processor) may be in communication with the data storage media 506 via a bus for passing information among components of the apparatus. The data storage media 506 is non-transitory and may include, for example, one or more volatile and/or non-volatile memories. In other words, for example, the data storage media 506 may be an electronic storage device (e.g., a computer-readable storage medium). The data storage media 506 may include one or more databases. Furthermore, the data storage media 506 may be configured to store information, data, content, applications, instructions, or the like for enabling the apparatus 500 to carry out various functions in accordance with example embodiments of the present invention.

The processor 502 may be embodied in several different ways and may, for example, include one or more processing devices configured to perform independently. In some preferred and non-limiting embodiments, the processor 502 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 502 may be configured to execute instructions stored in the data storage media 506 or otherwise accessible to the processor 502. In some preferred and non-limiting embodiments, the processor 502 may be configured to execute hard-coded functionalities. As such, whether configured by hardware or software methods, or by a combination thereof, the processor 502 may represent an entity (e.g., physically embodied in circuitry) capable of performing operations according to an embodiment of the present invention while configured accordingly. Alternatively, as another example, when the processor 502 is embodied as an executor of software instructions (e.g., computer program instructions), the instructions may specifically configure the processor 502 to perform the algorithms and/or operations described herein when the instructions are executed.

In some embodiments, the apparatus 500 may include input/output circuitry 504 that may, in turn, be in communication with processor 502 to provide output to the user and, in some embodiments, to receive an indication of a user input. The input/output circuitry 504 may comprise a user interface and may include a display, and may comprise a web user interface, a mobile application, a query-initiating computing device, a kiosk, or the like.

In embodiments in which the apparatus 500 is embodied by a limited interaction device, the input/output circuitry 504 includes a touch screen and does not include, or at least does not operatively engage (i.e., when configured in a table mode), other input accessories such as tactile keyboards, track pads, mice, etc. In other embodiments in which the apparatus is embodied by a non-limited interaction device, the input/output circuitry 504 may include at least one of a tactile keyboard (e.g., also referred to herein as keypad), a mouse, a joystick, a touch screen, touch areas, soft keys, and other input/output mechanisms. The processor and/or user interface circuitry comprising the processor may be configured to control one or more functions of one or more user interface elements through computer program instructions (e.g., software and/or firmware) stored on a memory accessible to the processor (e.g., data storage media 506, and/or the like).

The communications circuitry 508 may be any means such as a device or circuitry embodied in either hardware or a combination of hardware and software that is configured to receive and/or transmit data from/to a network and/or any other device, circuitry, or module in communication with the apparatus 500. In this regard, the communications circuitry 508 may include, for example, a network interface for enabling communications with a wired or wireless communication network. For example, the communications circuitry 508 may include one or more network interface cards, antennae, buses, switches, routers, modems, and supporting hardware and/or software, or any other device suitable for enabling communications via a network. Additionally, or alternatively, the communications circuitry 508 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 500. In some embodiments, one or more external systems (such as a remote cloud computing and/or data storage system) may also be leveraged to provide at least some of the functionality discussed herein.

FIG. 6 depicts an advanced dual pairing validation operation process 600. In some embodiments, an audio access point transceiver (e.g., audio access point transceiver 102, 202, 302, 402) may utilize an advanced wireless pairing interface (e.g., advanced wireless pairing interface 446) to perform an advanced dual pairing validation operation. At block 602, the audio access point transceiver performs, on a wireless control communication interface (e.g., wireless control communication interface 122, 222, 322, 422) a first pairing validation operation compliant with a first wireless communication protocol (e.g., Bluetooth®). As described herein, a wireless control communication interface may perform a pairing operation with a wireless control device to enable the exchange of encrypted wireless audio control signals. In some examples, the wireless control communication interface may send and receive wireless audio control signals according to a wireless communication protocol, for example Bluetooth®.

At block 604, the audio access point transceiver determines a wireless audio communication profile. The first pairing validation operation may include the determination of a wireless audio communication profile of a wireless control device (e.g., wireless control device 106, 206, 406). A wireless audio communication profile of a wireless control device may include but is not limited to PIN codes, addresses, names, link keys, encryption keys, identifiers, radio parameters, supported frequencies, and other parameters necessary to pair the wireless control device with the audio access point transceiver in compliance with the wireless communication protocol and authenticate the user account and/or profile including the set of settings and parameters.

At block 606, the audio access point transceiver recognizes a triggering event associated with the audio capture device (e.g., wireless audio capture device 108, 208, 408; dockable audio capture device 110, 410). A triggering event is any action or event resulting in the assignment or reassignment of an audio channel frequency to at least one audio capture device associated with the audio access point transceiver.

The pairing of an audio capture device to an audio access point transceiver (e.g., pairing event), or the unpairing of an audio capture device previously paired to an audio access point transceiver (e.g., unpairing event) may constitute a triggering event. Pairing of an audio capture device to an audio access point transceiver may occur manually, or automatically. For example, a manual pairing of an audio capture device may be triggered through an audio control user interface (e.g., audio control user interface 112, 212, 412), through a wireless control device connected via the wireless control communication interface, by pushing a button on the audio access point transceiver or audio capture device, or through an interface on the audio capture device or audio access point transceiver, each of which may constitute triggering events. In addition, in some embodiments a triggering event and subsequent pairing of an audio capture device may be manually initiated by docking or undocking an audio capture device in a docking port (e.g., docking port 120, 220, 420) of an audio access point transceiver or a remote audio capture device docking station.

The pairing of an audio capture device to an audio access point transceiver may also occur automatically, without manual intervention, based on a triggering event. For example, a triggering event may be recognized, and an automatic pairing of an audio capture device may be initiated based on the proximity of the audio capture device to one or more audio access point transceivers. An audio capture device and audio access point transceiver each comprise a wireless communication proximity. A wireless communication proximity is the distance, space, area, range, or other measurement representing the area in which wireless communication may be established with the audio capture device or the audio access point transceiver. For example, the wireless communication proximity may be the RF range of the associated device.

An automatic pairing of an audio capture device may be initiated in an instance in which an audio access point transceiver detects an unpaired audio capture device within the wireless communication proximity of the audio access point transceiver. For example, one or both of the audio access point transceiver and the unpaired audio device may periodically transmit an electrical signal (e.g., a beacon signal) indicating the radio frequency range within which the unpaired audio capture device may send, and the audio access point transceiver may receive audio signals. In an instance in which the unpaired audio capture device is determined to be within the radio frequency range of the audio capture device transceiver, the audio access point transceiver may recognize a triggering event and initiate an automatic pairing sequence.

In addition, a triggering event may be recognized, and a subsequent automatic pairing initiated in an instance in which an audio access point transceiver determines an audio capture device is in closer proximity to a second, closer audio access point transceiver, than to a previously paired first, distant audio access point transceiver. For example, in an instance in which the RF range of more than one audio access point transceivers overlap, an audio capture device may be detected by two audio access point transceivers. The movement of the audio capture device away from the first, paired audio access point transceiver and toward the second, unpaired audio access point transceiver may be recognized as a triggering event in an instance in which the audio capture device is determined to be closer to the second, unpaired audio access point transceiver. In such an instance, one or both of the audio access point transceivers may detect the change in proximity and the audio capture device may be automatically unpaired with the first audio access point transceiver and paired with the second audio access point transceiver. The unpairing of an audio capture device from an audio access point transceiver may also occur manually or automatically and may also constitute a triggering event. Manual unpairing events of a paired audio capture device may include but are not limited to docking or undocking an audio capture device from a docking port of an audio access point transceiver or a remote audio capture device docking station; selecting an audio capture device for unpairing through a wireless control device or audio control user interface; by pushing a button on the audio access point transceiver or audio capture device; through an interface on the audio capture device or audio access point transceiver; or similar means. Additionally, or alternatively, unpairing of an audio capture device from an audio access point transceiver may also occur automatically, without manual intervention. For example, automatic unpairing of an audio capture device may be initiated in an instance in which an audio access point transceiver detects an unpaired audio capture device leaving the wireless communication proximity of the audio access point transceiver or in an instance in which an audio capture device moves closer to an additional audio access point transceiver.

In some embodiments, in order to detect a triggering event, such as a proximity or location based triggering event, a wireless communication device, such as a Bluetooth® radio may be attached or associated with a wireless audio capture device. Attaching a wireless communication device to an associated wireless audio capture device may facilitate determination of the proximity of the associated audio capture device to one or more audio access point transceivers. For example, the audio access point transceiver may transmit a beacon signal enabling the wireless communication device associated with the wireless audio capture device to determine the distance of the wireless audio capture device from the audio access point transceiver. In some embodiments, the wireless communication device may be configured to send a beacon signal such that a receiving audio access point transceiver may determine the distance or proximity of the transmitting wireless audio capture device. In an instance in which the associated wireless audio capture device moves within a threshold distance of the audio access point transceiver, a triggering event may be detected, and a subsequent automatic pairing may be initiated.

At block 608, the audio access point transceiver performs on a wireless audio communication interface (e.g., wireless audio communication interface 114, 214, 314, 414) a second pairing validation operation compliant with a second wireless audio communication protocol (e.g., DECT). As described herein, a second pairing validation operation may be performed at the wireless audio communication interface to enable the exchange of wireless audio signals with a wireless audio capture device, according to a wireless communication protocol, for example, DECT.

The second pairing validation operation may include the exchange of data necessary to wirelessly communicate audio signals according to the second wireless communication protocol. For example, the audio capture device and the audio access point transceiver may transmit and receive PIN codes, addresses, names, link keys, encryption keys, identifiers, radio parameters, supported frequencies, and other parameters necessary to pair the wireless audio capture device with the audio access point transceiver in compliance with the wireless communication protocol.

At block 610, the audio access point transceiver performs a channel assignment operation. A channel assignment operation is any process, method, algorithm, or similar system, executed to assign one or more audio capture devices an audio channel frequency at which an audio signal from a paired audio capture device may be transmitted. As described herein, to transmit audio signals wirelessly, an audio capture device is configured to transmit the audio signal at a transmission frequency and the audio access point transceiver is configured to receive the audio signal by configuring a receiving radio to match the transmission frequency. A plurality of audio capture devices transmitting on the same or near the same transmission frequency may lead to interference in one or all of the transmitted audio signals. Thus, a channel assignment operation coordinates the audio channel frequencies associated with each audio capture device to minimize interference/cross talk and improve the overall audio quality of the audio capture system.

The channel assignment operation may comprise an audio channel allocation algorithm. An audio channel allocation algorithm is any set of rules dictating the assignment of audio channel frequencies or frequency bands to one or more audio capture devices. In some embodiments, the audio channel allocation algorithm may utilize historical utilization data to assign an audio channel frequency or frequency band to an audio capture device. For example, an audio access point transceiver may store data related to the usage of each audio channel frequency, such as the last audio capture device to transmit on a particular audio channel frequency, the time of use, the duration, and other similar data.

In an instance in which an audio capture device has previously been allocated an audio channel frequency on the audio access point transceiver, the controller may access historical utilization data and assign a previously used audio channel frequency or frequency band, if available. Similarly, in an instance in which the audio capture device has not been previously assigned an audio channel frequency, or a previously assigned audio channel frequency is currently assigned to another active audio capture device, the audio channel allocation algorithm may select an audio channel frequency that has never been used or is the least recently used audio channel frequency. Thus, newly paired audio capture devices are less likely to utilize an audio channel frequency of a frequently paired audio capture device.

In some embodiments, the audio channel allocation algorithm may utilize channel allocation settings to assign audio channel frequencies. Channel allocation settings are any settings or parameters indicating a priority or preference of an audio capture device relative to an audio access point transceiver. Channel allocation settings may be provided by a wireless control device, for example, through a user interface configured to communicate channel allocation settings. Channel allocation settings may be further provided through an audio control user interface (e.g., audio control user interface 112, 212, 412).

Channel allocation settings may comprise priority allocation settings. Priority allocation settings are any data or other indicator indicating a preference of one or more audio capture devices on an audio channel frequency or audio access point transceiver relative to one or more other audio capture devices. Priority allocation settings indicate a priority or list of priorities of an audio capture device on the audio access point transceiver or a particular audio channel frequency on the audio access point transceiver. For example, a wireless capture device permanently installed in a room may be assigned a high priority for a particular audio channel frequency, or similarly may be assigned the highest priority for the specific audio access point transceiver associated with the room.

Channel allocation setting may comprise fixed channel settings. Fixed channel settings comprise any data or other indicator configured to indicate a reserved audio channel frequency assignment to one or more audio capture devices. For example, a fixed channel setting may reserve an audio channel frequency for a particular audio capture device or group of audio capture devices whether any of the audio capture devices are paired, powered on, or active. Other audio capture devices may be denied access to transmit over a fixed channel, even in an instance in which the audio channel frequency is not currently utilized.

The audio channel allocation algorithm may also utilize device status properties to assign audio channel frequencies. Device status properties include any settings, properties, or parameters of an audio capture device indicating one or more characteristics of the audio capture device. Device status properties may include identity information of the audio capture device (e.g., identification number, identification string, identity of the user assigned to the audio capture device, etc.), audio capture device type (e.g., handheld microphone, bodypack microphone, lavalier microphone, in-ear monitor device, etc.), audio capture device role (e.g., presenter microphone, audience microphone, backstage staff microphone, etc.), the power state of the audio capture device (e.g., powered-on, powered off, standby, etc.), and other similar characteristics. Device status properties may be utilized to assign audio channel frequencies and/or priority of the audio capture device. For example, an audio capture device in a powered-on state may be assigned an available audio channel frequency over an audio capture device in a power-off state.

The device status properties may be utilized to similarly assign a priority to an audio capture device utilizing the same audio channel frequency. For example, a presenter microphone and an audience microphone may be assigned to the same audio channel frequency, however, in an instance in which both microphones are being utilized, the presenter microphone may be assigned a higher priority and temporarily override the audience microphone.

In addition, the device status properties may dictate which channel is assigned to a particular audio capture device. For instance, a particular audio access point transceiver may assign audio channel frequencies based on an affinity for a particular audio capture device on a particular channel. As an example, a lavalier microphone may be better suited for transmission of audio signals on a first audio channel frequency while a handheld microphone is generally better suited for transmission on a second audio channel frequency.

The audio channel allocation algorithm may further utilize a waiting queue to assign audio channel frequencies. A waiting queue is a list of available audio capture devices paired to an audio access point transceiver and waiting to be assigned an audio channel frequency to facilitate the transmission of audio signals to the audio access point transceiver. An audio capture device may be assigned to a waiting queue if all of the audio channel frequencies for an audio access point transceiver are utilized and/or otherwise unavailable to an audio capture device. In some embodiments, the audio capture devices listed on a waiting queue may be prioritized. Audio capture devices may be prioritized based on device status properties, priority allocation settings, fixed channel settings, or other prioritization mechanisms as discussed herein. In some embodiments, audio capture devices may be prioritized based on a first come, first served basis. An audio capture device listed in the waiting queue may be assigned an audio channel frequency when an audio channel frequency available to the audio capture device becomes available.

The audio channel allocation algorithm may further manage the assignment of audio channel frequencies during frequency hopping. An audio access point transceiver 102 may utilize frequency hopping techniques to rapidly switch between different frequency channels or frequency bands during operation. Frequency hopping may reduce interference and avoid interception of the transmitted signals. In some embodiments, such frequency hopping may be dictated based on the audio channel allocation algorithm.

At block 612, the audio access point transceiver distributes, via a wired control communication interface (e.g., wired audio communication interface 116, 216, 316, 416) audio signal data to an audio processing network (e.g., audio processing network 104, 204, 404) in compliance with one or more wired audio communication protocols. An audio access point transceiver receives audio signals from one or more audio capture devices, for example, wired audio capture devices, wireless audio captured devices, dockable audio capture devices, and so on. The audio access point transceiver is configured to prepare and transmit the received audio signals to an audio processing network on one or more audio transmission channels. Preparation of the received audio signals may include conversion, filtering, processing, and other actions necessary to transmit the audio signals as audio signal data according to the wired protocol of the wired audio communication interface. The transmitted audio signal data may be routed to various network connected audio devices to be further processed, filtered, routed, denoised, and otherwise distributed.

FIG. 7 depicts an example clock synchronization protocol 700. In some embodiments, an audio access point transceiver (e.g., audio access point transceiver 102, 202, 302, 402) may enable clock synchronization of a plurality of audio capture devices (e.g., wireless audio capture devices, dockable audio capture devices, wired audio capture devices, etc.), remote audio capture device docking stations, and other wirelessly connected and wired devices of an audio capture system (e.g., audio capture system 100, 200, 400). At block 702, the audio access point transceiver performs on a wireless control communication interface (e.g., wireless control communication interface 122, 222, 322, 422), a first pairing validation operation compliant with a first wireless communication protocol (e.g., Bluetooth®). As described herein, a wireless control communication interface may perform a pairing operation with a wireless control device to enable the exchange of encrypted wireless audio control signals. In some examples, the wireless control communication interface may send and receive wireless audio control signals according to a wireless communication protocol, for example Bluetooth®.

At block 704, the audio access point transceiver determines a wireless audio communication profile. The first pairing validation operation may include the determination of a wireless audio communication profile of a wireless control device (e.g., wireless control device 106, 206, 406). A wireless audio communication profile of a wireless control device may include but is not limited to PIN codes, addresses, names, link keys, encryption keys, identifiers, radio parameters, supported frequencies, and other parameters necessary to pair the wireless control device with the audio access point transceiver in compliance with the wireless communication protocol and authenticate the user account and/or profile including the set of settings and parameters.

At block 706, the audio access point transceiver performs on a wireless audio communication interface (e.g., wireless audio communication interface 114, 214, 314, 414) a second pairing validation operation compliant with a second wireless audio communication protocol (e.g., DECT) As described herein, a second pairing validation operation may be performed at the wireless audio communication interface to enable the exchange of wireless audio signals with a wireless audio capture device, according to a wireless communication protocol, for example DECT.

The second pairing validation operation may include the exchange of data necessary to wirelessly communicate audio signals according to the second wireless communication protocol. For example, the audio capture device and the audio access point transceiver may transmit and receive PIN codes, addresses, names, link keys, encryption keys, identifiers, radio parameters, supported frequencies, and other parameters necessary to pair the wireless audio capture device with the audio access point transceiver in compliance with the wireless communication protocol.

At block 708, the audio access point transceiver performs a channel assignment operation. A channel assignment operation may utilize a channel allocation algorithm to coordinate the audio channel frequencies associated with each audio capture device to minimize interference/cross talk and improve the overall audio quality of the audio capture system.

At block 710, the audio access point transceiver executes a clock synchronization protocol enabling clock synchronization of a plurality of audio capture devices (e.g., wireless audio capture devices 108, 208, 408; dockable audio capture devices 110, 410; wired audio capture devices 226). A clock synchronization protocol may be utilized to synchronize the audio signal data of a plurality of audio capture devices. The synchronization of audio capture devices across an audio capture system may enable synchronized transmission of audio signals from disparate wireless and wired audio capture devices. The clock synchronization protocol allows an audio capture system to transmit data without additional, time-consuming synchronization steps. The clock synchronization protocol reduces overall communication latency in the overall audio capture system and improves the overall quality of the capture and playback of audio signal data. Such optimization of the communication latency reduces audio signal lag or delay and improves the overall audio quality of an audio capture system.

The clock synchronization protocol may enable communication through a first wireless communication interface (e.g., wireless control communication interface 122, 222, 322, 422) to synchronize the clocks on a second wireless communication interface (e.g., wireless audio communication interface 114, 214, 314, 414). For example, the clock synchronization protocol may transmit a periodic synchronization initiation transmission on a Bluetooth® wireless communication interface to synchronized clocks on a DECT wireless communication interface. Utilizing a separate wireless communication interface to synchronize clocks may prevent the dedication of a channel of the first wireless communication interface to clock synchronization in an instance in which the channels of the first wireless communication interface are limited.

The clock synchronization protocol may also utilize a periodic synchronization initiation transmission. The periodic synchronization initiation transmission may be any data or signal transmitted at a regular period for purposes of synchronizing a receiving device to other receiving devices. In some embodiments, the clock synchronization protocol may designate a master clock device, for example, an audio access point transceiver. The master clock device may periodically transmit the periodic synchronization initiation transmission to coordinate the receiving audio capture devices with the clock of the master clock device. The periodicity of the transmission may depend on the setup of the audio capture system, the transmission medium, the performance requirements of the audio capture system, the content of the periodic synchronization transmission, and other similar factors. For example, in some embodiments, an audio capture system may require clock accuracy at a sub-millisecond precision.

The periodic synchronization initiation transmission may also include timestamp data. Timestamp data is any data or set of data indicating the timestamp of the clock distributed by the master clock device. The timestamp data may be used by a receiving audio capture device to synchronize audio signals with other audio capture devices. In some embodiments, the periodic synchronization initiation transmission may be transmitted over Bluetooth®.

At block 712, the audio access point transceiver distributes, via a wired control communication interface (e.g., wired audio communication interface 116, 216, 316, 416) audio signal data to an audio processing network (e.g., audio processing network 104, 204, 404) in compliance with one or more wired audio communication protocols. An audio access point transceiver receives audio signals from one or more audio capture devices, for example, wired audio capture devices, wireless audio captured devices, dockable audio capture devices, and so on. The audio access point transceiver is configured to prepare and transmit the received audio signals to an audio processing network on one or more audio transmission channels. Preparation of the received audio signals may include conversion, filtering, processing, and other actions necessary to transmit the audio signals as audio signal data according to the wired protocol of the wired audio communication interface. The transmitted audio signal data may be routed to various network connected audio devices to be further processed, filtered, routed, denoised, and otherwise distributed.

FIG. 8 depicts an example audio access point transceiver 802 structured in accordance with various embodiments and comprising a plurality of dockable audio capture devices 810a-810b docked in a plurality of docking ports 820a, 820b defined by an access point body 832.

The depicted docking ports 820a-820b may be configured to receive the docking end of one or more dockable audio capture devices 810a-810b positioned in a docking orientation. In addition, the docking port 820a-820b may include an electrical connector disposed in or near the docking port 820a-820b providing an electrical connection between the dockable audio capture device 810a-810b and the audio access point transceiver 802. The electrical connection provided by the electrical connector facilitates the transfer of power and data between the dockable audio capture device 810a-810b and the audio access point transceiver 802. The electrical connector may be configured to indicate to the dockable audio capture device 810a-810b an access point type via an access type indication voltage. The access point type may be indicated to the dockable audio capture device 810a-810b in an instance in which the docking port 820a-820b and/or the audio access point transceiver 802 is in a power-off state. The docking type indication process is discussed further in relation to FIG. 9. An example circuit diagram of an electrical connector enabling indication of an access point type is described in relation to FIG. 13.

FIG. 9 depicts an example access point type identification process 900. Although described primarily in relation to an audio access point transceiver (e.g., audio access point transceiver 102, 202, 302, 402, 802) the access point type identification process 900 may be similarly executed on an audio capture device docking station (e.g., audio capture device docking station 1060, 1160, 1260 as depicted in FIG. 10-FIG. 12).

At block 902, the audio access point transceiver performs on a wireless control communication interface (e.g., wireless control communication interface 122, 222, 322, 422), a first pairing validation operation compliant with a first wireless communication protocol (e.g., Bluetooth®). As described herein, a wireless control communication interface may perform a pairing operation with a wireless control device to enable the exchange of encrypted wireless audio control signals. In some examples, the wireless control communication interface may send and receive wireless audio control signals according to a wireless communication protocol, for example Bluetooth®.

At block 904, the audio access point transceiver determines a wireless audio communication profile. The first pairing validation operation may include the determination of a wireless audio communication profile of a wireless control device (e.g., wireless control device 106, 206, 406). A wireless audio communication profile of a wireless control device may include but is not limited to PIN codes, addresses, names, link keys, encryption keys, identifiers, radio parameters, supported frequencies, and other parameters necessary to pair the wireless control device with the audio access point transceiver in compliance with the wireless communication protocol and authenticate the user account and/or profile including the set of settings and parameters.

At block 906, the audio access point transceiver performs on a wireless audio communication interface (e.g., wireless audio communication interface 114, 214, 314, 414) a second pairing validation operation compliant with a second wireless audio communication protocol (e.g., DECT). As described herein, a second pairing validation operation may be performed at the wireless audio communication interface to enable the exchange of wireless audio signals with a wireless audio capture device, according to a wireless communication protocol, for example DECT.

The second pairing validation operation may include the exchange of data necessary to wirelessly communicate audio signals according to the second wireless communication protocol. For example, the audio capture device and the audio access point transceiver may transmit and receive PIN codes, addresses, names, link keys, encryption keys, identifiers, radio parameters, supported frequencies, and other parameters necessary to pair the wireless audio capture device with the audio access point transceiver in compliance with the wireless communication protocol.

At block 908, the audio access point transceiver performs a channel assignment operation. A channel assignment operation may utilize a channel allocation algorithm to coordinate the audio channel frequencies associated with each audio capture device to minimize interference/cross talk and improve the overall audio quality of the audio capture system.

At block 910, the audio access point transceiver receives a docking end of an audio capture device in a defined docking orientation relative to the audio access point transceiver. As depicted and described in relation to FIG. 8, a body of an audio access point transceiver may define a docking port (e.g., docking port 120, 220, 420, 820a-820b) configured to receive the docking end of an audio capture device in a docking orientation. In some embodiments, the docking port may be defined such that a plurality of audio capture devices of different shapes and sizes may be received into the docking port.

At block 912, the audio access point transceiver engages a reciprocal electrical connector on a dockable audio capture device with an electrical connector. A docking port may include an electrical connector comprising first and second circuit definition pins. Circuit definition pins are any conductive pins, conductive pads, wires, or other electrically conductive contact configured to generate one or more distinct voltages, currents, resistances, etc. when in electrical contact with a reciprocal connector of a dockable audio capture device.

In some embodiments, the electrical connector may be positioned in or near the docking port, such that in an instance in which the docking end of the dockable audio capture device is received in the docking port, the electrical connector engages a reciprocal electrical connector on the dockable audio capture device, establishing an electrical coupling between the dockable audio capture device and the audio access point transceiver. Such an electrical connection between the electrical connector on the audio access point transceiver and the reciprocal electrical connector on the dockable audio capture device may facilitate the transfer of power and data between the audio capture device and the audio access point transceiver. In addition, the reciprocal connector on the dockable audio capture device is electrically coupled to the first and second circuit definition pins of the electrical connector on the audio access point transceiver.

At block 914, the audio access point transceiver generates an access point type indication signal (e.g., docking type indication signal) over the first and second circuit definition pins. In some embodiments, a voltage, current, charge, etc. may be generated by the audio capture device, such that in an instance in which the reciprocal connector is electrically coupled to the circuit definition pins, one or more identifiable voltages, currents, and/or resistances are generated by the audio access point transceiver. The identifiable voltage, current, and/or resistance may be utilized to determine the type of the access point and/or docking station type. In some embodiments, the access point type indication signal may be generated in an instance in which the audio access point transceiver is in a power-off state.

At block 916, the audio access point transceiver initiates one or more capture device actions based on a power state of the access point transceiver. An audio access point transceiver may comprise a plurality of power states, such as “powered off,” “powered on,” “standby mode,” “sleep mode,” or any other state indicating the real-time power condition of the audio access point transceiver. An audio capture device may detect the power state of an audio access point transceiver based on measured voltages generated by the audio access point transceiver. An audio capture device may perform various actions based on the power state of the access point transceiver. For example, if the access point transceiver is powered off, the audio capture device may perform power down operations, disabling any wireless radios and powering off the audio capture device. Such an action may conserve the power of the audio capture device in an instance in which the audio access point transceiver is disabled. Additionally, or alternatively, an audio capture device may issue a no-power warning in an instance in which the audio access point transceiver is powered off. Such an action may alert a user to confirm the audio access point transceiver is receiving power and the audio capture device is charging.

At block 918, the audio access point transceiver distributes, via a wired control communication interface (e.g., wired audio communication interface 116, 216, 316, 416) audio signal data to an audio processing network (e.g., audio processing network 104, 204, 404) in compliance with one or more wired audio communication protocols. An audio access point transceiver receives audio signals from one or more audio capture devices, for example, wired audio capture devices, wireless audio captured devices, dockable audio capture devices, and so on. The audio access point transceiver is configured to prepare and transmit the received audio signals to an audio processing network on one or more audio transmission channels. Preparation of the received audio signals may include conversion, filtering, processing, and other actions necessary to transmit the audio signals as audio signal data according to the wired protocol of the wired audio communication interface. The transmitted audio signal data may be routed to various network connected audio devices to be further processed, filtered, routed, denoised, and otherwise distributed.

FIG. 10 depicts an example audio capture device docking station 1060 including a docking station body 1062 defining two docking ports 1064a, 1064b connected to dockable audio capture devices 1070a-1070b.

The docking port 1064a-1064b may be configured to receive the docking end of one or more dockable audio capture devices 1070a-1070b positioned in a docking orientation. In addition, the docking port 1064a-1064b may include an electrical connector disposed in or near the docking port 1064a-1064b providing an electrical connection between the dockable audio capture device 1070a-1070b and the audio capture device docking station 1060. The electrical connection provided by the electrical connector facilitates the transfer of power and data between the dockable audio capture device 1070a-1070b and the audio capture device docking station 1060. In addition, the electrical connector may be configured to indicate to the dockable audio capture device 1070a-1070b a docking port type via a docking type indication signal. The docking port type may be indicated to the dockable audio capture device 1070a-1070b in an instance in which the docking port 1064a-1064b and/or the audio capture device docking station 1060 is in a power-off state. An example circuit diagram of an electrical connector enabling indication of an access point type is described in relation to FIG. 13.

FIG. 11 depicts an example audio capture device docking station 1160 structured in accordance with various embodiments. The depicted audio capture device docking station 1160 includes a docking station body 1162 defining two docking ports 1164. Although the example audio capture device docking station 1160 includes two docking ports 1164, an audio capture device docking station 1160 may be configured with any number (e.g., 2, 4, 6, etc.) of docking ports 1164. The docking ports 1164 are structured to define a docking cavity having a locating feature 1168 as shown. The docking cavity of the docking ports 1164 are configured to slideably receive the docking end of a dockable audio capture device and the locating feature 1168 of the docking cavity is structured to align with a reciprocally structured locking feature defined by the docking end of the dockable audio capture device to ensure that the dockable audio capture device is locked into a docking orientation. The electrical connectors 1166 disposed within the docking ports 1164, establish an electrical connection between the dockable audio capture device and the audio capture device docking station 1160.

The depicted audio capture device docking station 1160 includes a docking port 1164. A docking port 1164 is any port, slot, cavity, or other opening configured to receive the docking end of a dockable audio capture device. A docking port 1164 may be shaped to slideably receive the docking end of one or more dockable audio capture devices in a particular docking orientation that encourages a robust electrical connection. In some embodiments, the docking port 1164 may be shaped to uniquely match the docking end of a dockable audio capture device.

In addition, the docking port 1164 includes an electrical connector 1166 disposed in the docking port 1164 and providing an electrical connection between the dockable audio capture device and the audio capture device docking station 1160. The electrical connection provided by the electrical connector 1166 may facilitate the transfer of power and data between the dockable audio capture device and the audio capture device docking station 1160. In some embodiments, such as the depicted embodiment of FIG. 11, the electrical connector 1166 may include a USB connection.

In some embodiments, the electrical connector 1166 may comprise docking type definition circuitry comprising one or more circuit definition pins and configured to generate a docking type indication signal (e.g., access point indication voltage as described in FIG. 9) to the dockable audio capture device. A voltage, current, resistance, etc. may be determined by the dockable audio capture device, such that in an instance in which the reciprocal connector of the dockable audio capture device is electrically coupled to the circuit definition pins, one or more identifiable voltages, currents, resistances, etc. are generated by the audio capture device docking station 1160. The identifiable voltage, current, or resistance may be utilized to determine the docking station type of the docking station. In some embodiments, the docking station type indication voltage may be generated in an instance in which the audio capture device docking station is in a power-off state.

The audio capture device docking station may initiate one or more capture device actions based on a power state of the audio capture device docking station. An audio capture device docking station may comprise a plurality of power states, such as “powered off,” “powered on,” “standby mode,” “sleep mode,” or any other state indicating the real-time power condition of the audio capture device docking station. An audio capture device may detect the power state of an audio capture device docking station based on measured voltages generated by the audio capture device docking station. An audio capture device may perform various actions based on the power state of the audio capture device docking station. For example, if the audio capture device docking station is powered off, the audio capture device may perform power down operations, disabling any wireless radios and powering off the audio capture device. Such an action may conserve the power of the audio capture device in an instance in which the audio access point transceiver is disabled. Additionally, or alternatively, an audio capture device may issue a no-power warning in an instance in which the audio capture device docking station is powered off. Such an action may alert a user to confirm the audio access point transceiver is receiving power and the audio capture device is charging.

The docking station type may be indicated to the dockable audio capture device in an instance in which the docking port 1164 and/or the audio capture device docking station 1160 is in a power-off state. An example circuit diagram of an electrical connector 1166 enabling indication of a docking station type is described in relation to FIG. 13.

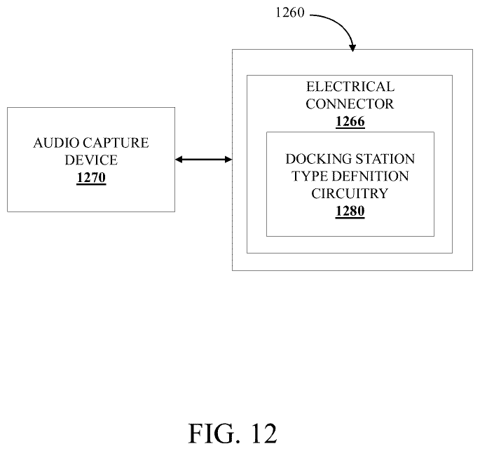

FIG. 12 depicts a schematic block diagram of an example audio capture device docking station 1260 and an electrically coupled dockable audio capture device 1270 is. The depicted audio capture device docking station 1260 includes an electrical connector 1266 including docking type definition circuitry 1280. The docking type definition circuitry 1280 is electrically coupled to the audio capture device 1270 in an instance in which the audio capture device 1270 is electrically coupled with an electrical connector 1266 of the audio capture device docking station 1260.

The depicted audio capture device docking station 1260 includes docking type definition circuitry 1280. Docking type definition circuitry 1280 is any circuitry including hardware and/or software configured to generate a docking type indication signal via an electrical connector. Docking type definition circuitry 1280 includes a plurality of circuit definition pins, such that in an instance in which a dockable audio capture device 1270 is electrically coupled to the audio capture device docking station 1260, the docking type definition circuitry 1280 generates a unique docking type indication signal, indicating to the dockable audio capture device 1270 the type of the docking port and/or the type of the audio capture device docking station 1260. Further, the docking type definition circuitry 1280 may indicate the orientation of the connector of the dockable audio capture device 1270 relative to the electrical connector.

The docking type definition circuitry 1280 may indicate the docking station type in an instance in which the docking port and/or audio capture device docking station 1260 are disposed in a power-off state. In such an instance, the docking port may initiate one or more audio capture device actions on the dockable audio capture device 1270. In some embodiments, the docking type definition circuitry 1280 may be integrated with the electrical connector, for example a USB connector. An example circuit diagram for example docking type definition circuitry 1280 is provided in FIG. 13.

FIG. 13 depicts an example circuit diagram of docking type definition circuitry 1380 (e.g., docking type definition circuitry 454, 1280). The depicted docking type definition circuitry 1380 includes a first circuit definition pin 1388 and a second circuit definition pin 1390 each providing a conductive contact to the docking type definition circuitry 1380. The depicted docking type definition circuitry 1380 includes a first resistor 1382 disposed between the first circuit definition pin 1388 and the second circuit definition pin 1390, electrically connecting the first circuit definition pin 1388 and the second circuit definition pin 1390. A second resistor 1384 is electrically connected between the first circuit definition pin 1388 and electrical ground. A third resistor is electrically connected between the second circuit definition pin 1390 and electrical ground.

The depicted docking type definition circuitry 1380 is configured to produce a docking type indication signal between the first circuit definition pin 1388 and the second circuit definition pin 1390 in an instance in which a dockable audio capture device applies a voltage, current, or charge to the docking type definition circuitry 1380. The docking type indication signal may be detected to identify the type of the associated docking station (and/or audio access point transceiver). The example docking type definition circuitry 1380 depicted in FIG. 13 additionally enables a dockable audio capture device to receive the docking type indication signal in an instance in which the docking port, docking station, or audio access point transceiver is powered off.

The depicted docking type definition circuitry 1380 may further enable flip detection mechanisms. Flip detection mechanisms may be utilized to indicate to an electrically connected audio capture device the orientation of the electrical connection. For example, the docking type definition circuitry 1380 may exhibit a first voltage, current, resistance, etc. at the first circuit definition pin 1388 and a second voltage, current, resistance, etc. at the second circuit definition pin 1390. By exhibiting different voltages, currents, charges, etc. on the first circuit definition pin 1388 versus the second circuit definition pin 1390, an electrically connected audio capture device may determine the orientation of the electrical connector with respect to the audio capture device.

While this detailed description has set forth some embodiments of the present invention, the appended claims cover other embodiments of the present invention which differ from the described embodiments according to various modifications and improvements. For example, one skilled in the art may recognize that such principles may be applied to any audio access point configured to receive wireless audio signals and transmit the audio signals as audio data to an audio processing network.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

Hereinafter, various characteristics will be highlighted in a set of numbered clauses or paragraphs. These characteristics are not to be interpreted as being limiting on the invention or inventive concept but are provided merely as a highlighting of some characteristics as described herein, without suggesting a particular order of importance or relevancy of such characteristics.

Clause 1. An audio access point transceiver configured to send and receive encrypted wireless audio signals to and from audio capture devices and distribute audio signal data to an audio processing network, the audio access point transceiver comprising: a wireless control communication interface configured to support one or more first pairing validation operations compliant with a first wireless communication protocol, wherein the one or more first pairing validation operations comprises determining a wireless audio communication profile, wherein the wireless audio communication profile enables sending and receiving encrypted wireless audio control signals to and from audio capture devices; a wireless audio communication interface configured to support a second pairing validation operation compliant with a second wireless communication protocol, wherein the second pairing validation operation comprises a channel assignment operation, wherein the channel assignment operation enables sending and receiving encrypted wireless audio signals to and from audio capture devices; and a wired audio communication interface configured to support one or more wired audio communication protocols, wherein the wired audio communication interface enables distribution of the audio signal data via one or more wired audio communication protocols to the audio processing network.

Clause 2. An audio access point transceiver according to the foregoing Clause, further comprising: a wired control communication interface configured to support one or more wired control communication protocols, wherein the one or more wired control communication protocols enable control of the distribution of the audio signal data to the audio processing network.

Clause 3. An audio access point transceiver according to any of the foregoing Clauses, wherein the wireless control communication interface sends and receives encrypted wireless audio control signals to and from audio capture devices in compliance with a Bluetooth® wireless communication protocol.

Clause 4. An audio access point transceiver according to any of the foregoing Clauses, wherein the wireless audio control signals comprise channel allocation settings.

Clause 5. An audio access point transceiver according to any of the foregoing Clauses, wherein the channel allocation settings comprise priority allocation settings indicating a priority of one or more audio capture devices.

Clause 6. An audio access point transceiver according to any of the foregoing Clauses, wherein the channel allocation settings comprise fixed channel settings indicating a reserved audio channel frequency assignment for one or more audio capture devices.

Clause 7. An audio access point transceiver according to any of the foregoing Clauses, wherein the wireless audio communication profile comprises a list of preferred audio capture devices, indicating a preference for the preferred audio capture devices on the audio access point transceiver.

Clause 8. An audio access point transceiver according to any of the foregoing Clauses, wherein the wireless audio communication profile is associated with a dual radio audio capture device configured to communicate with the wireless control communication interface and the wireless audio communication interface of the audio access point transceiver, and wherein the channel assignment operation associated with the second pairing validation operation comprises assigning an audio channel frequency for the dual radio audio capture device.

Clause 9. An audio access point transceiver according to any of the foregoing Clauses, wherein the wireless audio communication interface sends and receives encrypted wireless audio signals to and from audio capture devices in compliance with a digital enhanced cordless telecommunications protocol (DECT) wireless communication protocol.

Clause 10. An audio access point transceiver according to any of the foregoing Clauses, wherein the second pairing validation operation comprising a channel assignment operation is executed based on a triggering event.

Clause 11. An audio access point transceiver according to any of the foregoing Clauses, wherein the triggering event comprises at least one of a pairing event between a pairing audio capture device and the audio access point transceiver, and an unpairing event between an unpairing audio capture device and the audio access point transceiver.

Clause 12. An audio access point transceiver according to any of the foregoing Clauses, wherein the pairing event follows the pairing audio capture device being disposed in electrical communication with the audio access point transceiver via a docking port of the audio access point transceiver.

Clause 13. An audio access point transceiver according to any of the foregoing Clauses, wherein the pairing event is initiated based on the pairing audio capture device being disposed in a wireless communication proximity to the audio access point.

Clause 14. An audio access point transceiver according to any of the foregoing Clauses, wherein the wireless communication proximity of the audio capture device to the audio access point transceiver is based on a transmission range of a beacon signal.

Clause 15. An audio access point transceiver according to any of the foregoing Clauses, wherein the beacon signal is transmitted by the audio access point transceiver or the audio capture device.

Clause 16. An audio access point transceiver according to any of the foregoing Clauses, wherein the channel assignment operation assigns one or more audio capture devices to respective audio channel frequencies based on an audio channel allocation algorithm.

Clause 17. An audio access point transceiver according to any of the foregoing Clauses, wherein the audio channel allocation algorithm determines an audio channel frequency for an audio capture device based on a historical utilization of one or more audio channel frequencies.

Clause 18. An audio access point transceiver according to any of the foregoing Clauses, wherein the audio channel allocation algorithm determines an audio channel frequency for an audio capture device based on one or more device status properties of the audio capture device.

Clause 19. An audio access point transceiver according to any of the foregoing Clauses, wherein the device status properties of the audio capture device comprise at least one of identity information of the audio capture device, an audio capture device type, an audio capture device role, and a power state of the audio capture device.

Clause 20. An audio access point transceiver according to any of the foregoing Clauses, wherein the audio channel allocation algorithm comprises a waiting queue, wherein the waiting queue comprises one or more audio capture devices paired to the audio access point transceiver awaiting an assigned audio channel frequency.

Clause 21. An audio access point transceiver according to any of the foregoing Clauses, further comprising a clock synchronization protocol, wherein the clock synchronization protocol enables a synchronization of clocks of a plurality of audio capture devices.

Clause 22. An audio access point transceiver according to any of the foregoing Clauses, wherein the clock synchronization protocol comprises a periodic synchronization initiation transmission.

Clause 23. An audio access point transceiver according to any of the foregoing Clauses, wherein the periodic synchronization initiation transmission comprises timestamp data.

Clause 24. An audio access point transceiver according to any of the foregoing Clauses, wherein the periodic synchronization initiation transmission is transmitted via the wireless control communication interface.

Clause 25. An audio access point transceiver according to any of the foregoing Clauses, wherein the periodic synchronization initiation transmission is transmitted via the wireless control communication interface to enable synchronization of a clock between the audio access point transceiver and a synchronized wireless audio capture device on the wireless audio communication interface.

Clause 26. An audio access point transceiver according to any of the foregoing Clauses, wherein the periodic synchronization initiation transmission is transmitted in accordance with a Bluetooth® wireless communication protocol.

Clause 27. An audio access point transceiver according to any of the foregoing Clauses, further comprising: docking port defined by an access point body of the audio access point transceiver, wherein the audio access point transceiver is configured to electronically indicate an access point type associated with the audio access point transceiver to a dockable audio capture device via the docking port.

Clause 28. An audio access point transceiver according to any of the foregoing Clauses, wherein the docking port is configured to slideably receive a docking end of an audio capture device in a defined docking orientation relative to the audio access point transceiver.

Clause 29. An audio access point transceiver according to any of the foregoing Clauses, further comprising: an electrical connector comprising first and second circuit definition pins positioned within the docking port, the electrical connector further comprising: docking type definition circuitry configured to produce an access point type indication signal over the first and second circuit definition pins when the docking end of the audio capture device is slideably received into the docking port.

Clause 30. An audio access point transceiver according to any of the foregoing Clauses, wherein the electrical connector comprises a universal serial bus (USB) port.

Clause 31. An audio access point transceiver according to any of the foregoing Clauses, wherein the first and second circuit definition pins comprise sideband use (SBU) pins.

Clause 32. An audio access point transceiver according to any of the foregoing Clauses, wherein the docking type definition circuitry is configured to produce the access point type indication signal in an instance in which the audio access point transceiver is in a power-off state.

Clause 33. An audio access point transceiver according to any of the foregoing Clauses, wherein the docking type definition circuitry of the audio access point transceiver is further configured to initiate one or more audio capture device actions based on a power state of the audio access point transceiver.

Clause 34. An audio access point transceiver according to any of the foregoing Clauses, wherein the one or more audio capture device actions include at least one of: causing the audio capture device to issue a no-power warning and causing the audio capture device to execute power down operations.

Clause 35. An audio access point transceiver according to any of the foregoing Clauses, wherein the wired audio communication interface distributes audio signal data in compliance with a Dante wired audio communication protocol.

Clause 36. An audio access point transceiver according to any of the foregoing Clauses, wherein the wired control communication interface enables control of the distribution of the audio signal data in compliance with an ethernet wired control communication protocol.

Clause 37. A computer-implemented method comprising steps in accordance with any of the foregoing Clauses.

Clause 38. A computer program product, stored on a computer readable medium and comprising instructions that, when executed by one or more processors, cause the one or more processors to perform steps in accordance with any of the foregoing Clauses.

Clause 39. An audio access point transceiver comprising at least one processor and a memory storing instructions that are operable, when executed by the at least one processor, to cause the apparatus to: perform, via a wireless control communication interface of an audio access point transceiver, a first pairing validation operation compliant with a first wireless communication protocol, wherein the first pairing validation operation enables sending and receiving encrypted wireless audio control signals to and from one or more audio capture devices; perform, via a wireless audio communication interface of the audio access point transceiver, a second pairing validation operation, wherein the second pairing validation operation enables sending and receiving encrypted wireless audio signals to and from the audio capture device; and distributing, via a wired control communication interface of the audio access point transceiver, audio signal data to an audio processing network.

Clause 40. An audio capture device docking station configured for charging one or more audio capture devices, the audio capture device docking station comprising: a docking station body defining a docking port, wherein the docking port is configured to slideably receive a docking end of an audio capture device; an electrical connector positioned within the docking port, wherein the electrical connector comprises first and second circuit definition pins; and docking type definition circuitry configured to produce a docking type indication signal over the first and second circuit definition pins when the docking end of the audio capture device is slideably received into the docking port.

Clause 41. An audio capture device docking station according to the foregoing Clause, wherein the electrical connector comprises a universal serial bus (USB) connector.

Clause 42. An audio capture device docking station according to any of the foregoing Clauses, wherein the first and second circuit definition pins comprise sideband use (SBU) pins.

Clause 43. An audio capture device docking station according to any of the foregoing Clauses, wherein the docking type definition circuitry is configured to produce the docking type indication signal in an instance in which the audio capture device docking station is disposed in a power off state.

Clause 44. An audio capture device docking station according to any of the foregoing Clauses, wherein the docking type definition circuitry of the audio capture device docking station is further configured to initiate one or more audio capture device actions based on a power state of the audio capture device docking station.

Clause 45. An audio capture device docking station according to any of the foregoing Clauses, wherein the one or more audio capture device actions include at least one of: causing the audio capture device to issue a no-power warning and causing the audio capture device to execute power down operations.

Clause 46. An audio capture device docking station according to any of the foregoing Clauses, further comprising: a wireless control communication interface configured to support one or more first pairing validation operations compliant with a first wireless communication protocol, wherein the one or more first pairing validation operations comprises determining a wireless audio communication profile, wherein the wireless audio communication profile enables sending and receiving encrypted wireless audio control signals to and from audio capture devices.

Clause 47. An audio capture device docking station according to any of the foregoing Clauses, further comprising: a wireless audio communication interface configured to support a second pairing validation operation compliant with a second wireless communication protocol, wherein the second pairing validation operation comprises a channel assignment operation, wherein the channel assignment operation enables sending and receiving encrypted wireless audio signals to and from audio capture devices.

Clause 48. An audio capture device docking station according to any of the foregoing Clauses, further comprising: a wired audio communication interface configured to support one or more wired audio communication protocols, wherein the wired audio communication interface enables distribution of audio signal data via one or more wired audio communication protocols to an audio processing network.

Clause 49. An audio capture device docking station according to any of the foregoing Clauses, further comprising: a wired control communication interface configured to support one or more wired control communication protocols, wherein the one or more wired control communication protocols enable control of the distribution of audio signal data to an audio processing network.

Clause 50. A computer-implemented method comprising steps in accordance with any of Clauses 40-49

Clause 51. A computer program product, stored on a computer readable medium and comprising instructions that, when executed by one or more processors, cause the one or more processors to perform steps in accordance with any of Clauses 40-49.

Clause 52. An audio capture device docking station, comprising: a docking port configured to slideably receive a docking end of an audio capture device; an electrical connector comprising first and second circuit definition pins; and docking type definition circuitry configured to produce a docking type indication signal via the first and second circuit definition pins when the docking end of the audio capture device is slideably received into the docking port.

Clause 53. A method for assigning an audio capture device to an audio channel frequency, the method comprising: performing, via a wireless control communication interface of an audio access point transceiver, a first pairing validation operation compliant with a first wireless communication protocol, wherein the first pairing validation operation comprises determining a wireless audio communication profile, and wherein the wireless audio communication profile enables sending and receiving encrypted wireless audio control signals to and from one or more audio capture devices; recognizing a triggering event associated with the audio capture device; performing, via a wireless audio communication interface of the audio access point transceiver, a second pairing validation operation compliant with a second wireless audio communication protocol, wherein the second pairing validation operation comprises a channel assignment operation, and wherein the channel assignment operation enables sending and receiving encrypted wireless audio signals to and from the audio capture device; and distributing, via a wired control communication interface of the audio access point transceiver, audio signal data to an audio processing network in compliance with one or more wired audio communication protocols.

Clause 54. A method according to the foregoing Clause, wherein the wireless audio control signals comprise channel allocation settings.

Clause 55. A method according to any of the foregoing Clauses, wherein the channel allocation settings further comprise one or more priority allocation settings indicating a priority of the one or more audio capture devices, and wherein the channel assignment operation further comprises: assigning the audio channel frequency to the audio capture device based on the one or more priority allocation settings.

Clause 56. A method according to any of the foregoing Clauses, wherein the channel allocation settings further comprise one or more fixed channel settings indicating a reserved audio channel frequency assignment for the one or more audio capture devices, and wherein the channel assignment operation further comprises: assigning the audio channel frequency to the audio capture device based on the one or more fixed channel settings.

Clause 57. A method according to any of the foregoing Clauses, wherein the channel assignment operation further comprises assigning the audio channel frequency to the audio capture device based on a list of preferred audio capture devices, wherein the list of preferred audio capture devices indicates a preference for the one or more audio capture devices on the audio access point transceiver.

Clause 58. A method according to any of the foregoing Clauses, further comprising executing the second pairing validation operation comprising a channel assignment operation based on a triggering event.

Clause 59. A method according to any of the foregoing Clauses, wherein the channel assignment operation further comprises assigning the audio channel frequency to the audio capture device based on an audio channel allocation algorithm.

Clause 60. A method according to any of the foregoing Clauses, wherein the audio channel allocation algorithm further comprises determining an audio channel frequency for an audio capture device based on a historical utilization of one or more audio channel frequencies.

Clause 61. A method according to any of the foregoing Clauses, wherein the audio channel allocation algorithm further comprises receiving one or more device status properties of the audio capture device; and determining an audio channel frequency for an audio capture device based on the one or more device status properties of the audio capture device.

Clause 62. A method according to any of the foregoing Clauses, wherein the device status properties of the audio capture device comprise one or more of identity information of the audio capture device, an audio capture device type, an audio capture device role, or a power state of the audio capture device.

Clause 63. A method according to any of the foregoing Clauses, wherein the audio channel allocation algorithm further comprises assigning an audio capture device to a waiting queue, wherein the waiting queue comprises one or more audio capture devices paired to the audio access point transceiver awaiting an assigned audio channel frequency.

Clause 64. A method for indicating an access point type associated with an audio access point transceiver to a dockable audio capture device, the method comprising: performing, via a wireless control communication interface of the audio access point transceiver, a first pairing validation operation compliant with a first wireless communication protocol, wherein the first pairing validation operation comprises determining a wireless audio communication profile, and wherein the wireless audio communication profile enables sending and receiving encrypted wireless audio control signals to and from one or more audio capture devices; performing, via a wireless audio communication interface of the audio access point transceiver, a second pairing validation operation compliant with a second wireless audio communication protocol, wherein the second pairing validation operation comprises a channel assignment operation, and wherein the channel assignment operation enables sending and receiving encrypted wireless audio signals to and from the dockable audio capture device; receiving a docking end of the dockable audio capture device in a defined docking orientation relative to the audio access point transceiver; engaging a reciprocal electrical connector on the dockable audio capture device with an electrical connector, wherein the electrical connector comprises first and second circuit definition pins; generating an access point type indication signal over the first and second voltage definition pins; initiating one or more audio capture device actions based on a power state of the access point transceiver; and distributing, via a wired control communication interface of the audio access point transceiver, audio signal data to an audio processing network in compliance with one or more wired audio communication protocols.

Clause 65. A method according to the foregoing Clause, wherein the electrical connector is positioned within the docking port, and wherein the electrical connector comprises docking type definition circuitry configured to produce an access point type indication signal over a first circuit definition pin and a second circuit definition pin in an instance in which the docking end of the dockable audio capture device is slideably received into the docking port.

Clause 66. A method according to any of the foregoing Clauses, wherein the electrical connector comprises a universal serial bus (USB) port.

Clause 67. A method according to any of the foregoing Clauses, wherein the first and second circuit definition pins comprise sideband use (SBU) pins.

Clause 68. A method according to any of the foregoing Clauses, further comprising generating, by the docking type definition circuitry, the access point type indication signal in an instance in which the audio access point transceiver is in a power-off state.

Clause 69. A method according to any of the foregoing Clauses, further comprising initiating one or more audio capture device actions based on a power state of the audio access point transceiver.

Clause 70. A method according to any of the foregoing Clauses, wherein the one or more audio capture device actions include at least one of: causing the dockable audio capture device to issue a no-power warning and causing the dockable audio capture device to execute power down operations.

Clause 71. A method for synchronizing a plurality of clocks on a subset of audio capture devices in communication with an audio access point transceiver, the method comprising: performing, via a wireless control communication interface of the audio access point transceiver, a first pairing validation operation compliant with a first wireless communication protocol, wherein the first pairing validation operation comprises determining a wireless audio communication profile, and wherein the wireless audio communication profile enables sending and receiving encrypted wireless audio control signals to and from a plurality of audio capture devices comprising at least the subset of audio capture devices; performing, via a wireless audio communication interface of the audio access point transceiver, a second pairing validation operation compliant with a second wireless audio communication protocol, wherein the second pairing validation operation comprises a channel assignment operation, and wherein the channel assignment operation enables sending and receiving encrypted wireless audio signals to and from the plurality audio capture devices; executing a clock synchronization protocol enabling clock synchronization of the subset of audio capture devices; distributing, via a wired control communication interface of the audio access point transceiver, audio signal data to an audio processing network in compliance with one or more wired audio communication protocols.

Clause 72. A method according to the foregoing Clause, wherein executing the clock synchronization protocol further comprises transmitting a periodic synchronization initiation transmission.

Clause 73. A method according to any of the foregoing Clauses, wherein the periodic synchronization initiation transmission comprises timestamp data.

Clause 74. A method according to any of the foregoing Clauses, wherein the periodic synchronization initiation transmission is transmitted via the wireless control communication interface.

Clause 75. A method according to any of the foregoing Clauses, wherein the periodic synchronization initiation transmission is transmitted via the wireless control communication interface to a wireless audio capture device enabling synchronization of wireless audio signals transmitted on a wireless audio communication interface.

Clause 76. A method according to any of the foregoing Clauses, wherein the periodic synchronization initiation transmission is transmitted in accordance with a Bluetooth® wireless communication protocol.

1. An audio access point transceiver configured to send and receive encrypted wireless audio signals to and from audio capture devices and distribute audio signal data to an audio processing network, the audio access point transceiver comprising:
a wireless control communication interface configured to support one or more first pairing validation operations compliant with a first wireless communication protocol, wherein the one or more first pairing validation operations comprises determining a wireless audio communication profile, wherein the wireless audio communication profile enables sending and receiving encrypted wireless audio control signals to and from audio capture devices;
a wireless audio communication interface configured to support a second pairing validation operation compliant with a second wireless communication protocol, wherein the second pairing validation operation comprises a channel assignment operation, wherein the channel assignment operation enables sending and receiving encrypted wireless audio signals to and from audio capture devices; and
a wired audio communication interface configured to support one or more wired audio communication protocols, wherein the wired audio communication interface enables distribution of the audio signal data via one or more wired audio communication protocols to the audio processing network.

2. The audio access point transceiver of claim 1, further comprising:
a wired control communication interface configured to support one or more wired control communication protocols, wherein the one or more wired control communication protocols enable control of the distribution of the audio signal data to the audio processing network.

3. (canceled)

4. The audio access point transceiver of claim 1, wherein the wireless audio control signals comprise channel allocation settings.

5. The audio access point transceiver of claim 4, wherein the channel allocation settings comprise priority allocation settings indicating a priority of one or more audio capture devices.

6. The audio access point transceiver of claim 4, wherein the channel allocation settings comprise fixed channel settings indicating a reserved audio channel frequency assignment for one or more audio capture devices.

7. The audio access point transceiver of claim 1, wherein the wireless audio communication profile comprises a list of preferred audio capture devices, indicating a preference for the preferred audio capture devices on the audio access point transceiver.

8. (canceled)

9. (canceled)

10. The audio access point transceiver of claim 1, wherein the second pairing validation operation comprising a channel assignment operation is executed based on a triggering event.

11. The audio access point transceiver of claim 10, wherein the triggering event comprises at least one of a pairing event between a pairing audio capture device and the audio access point transceiver, and an unpairing event between an unpairing audio capture device and the audio access point transceiver.

12. The audio access point transceiver of claim 11, wherein the pairing event follows the pairing audio capture device being disposed in electrical communication with the audio access point transceiver via a docking port of the audio access point transceiver.

13. The audio access point transceiver of claim 11, wherein the pairing event is initiated based on the pairing audio capture device being disposed in a wireless communication proximity to the audio access point transceiver.

14. The audio access point transceiver of claim 13, wherein the wireless communication proximity of the pairing audio capture device to the audio access point transceiver is based on a transmission range of a beacon signal.

15. (canceled)

16. The audio access point transceiver of claim 1, wherein the channel assignment operation assigns one or more audio capture devices to respective audio channel frequencies based on an audio channel allocation algorithm.

17. The audio access point transceiver of claim 16, wherein the audio channel allocation algorithm determines an audio channel frequency for an audio capture device based on a historical utilization of one or more audio channel frequencies.

18. The audio access point transceiver of claim 16, wherein the audio channel allocation algorithm determines an audio channel frequency for an audio capture device based on one or more device status properties of the audio capture device.

19. The audio access point transceiver of claim 18, wherein the device status properties of the audio capture device comprise at least one of identity information of the audio capture device, an audio capture device type, an audio capture device role, and a power state of the audio capture device.

20. The audio access point transceiver of claim 16, wherein the audio channel allocation algorithm comprises a waiting queue, wherein the waiting queue comprises one or more audio capture devices paired to the audio access point transceiver awaiting an assigned audio channel frequency.

21-76. (canceled)

77. A computer-implemented method on an audio access point transceiver, the computer-implemented method comprising:
executing, at a wireless control communication interface, a first pairing validation operation compliant with a first wireless communication protocol,
wherein the first pairing validation operations comprises determining a wireless audio communication profile;
sending and receiving encrypted wireless audio control signals to and from audio capture devices in accordance with the wireless audio communication profile;
executing, at a wireless audio communication interface, a second pairing validation operation compliant with a second wireless communication protocol,
wherein the second pairing validation operation comprises a channel assignment operation;
sending and receiving encrypted wireless audio signals to and from audio capture devices in accordance with the channel assignment operation;
distributing, at a wired audio communication interface configured to support one or more wired audio communication protocols, audio signal data to an audio processing network via one or more wired audio communication protocols.

78. The computer-implemented method of claim 77, further comprising:
controlling a distribution of the audio signal data to the audio processing network by a wired control communication interface configured to support one or more wired control communication protocols.

79. The computer-implemented method of claim 77, further comprising:
transmitting, by the audio control signals, channel allocation settings to the audio capture devices.

80. The computer-implemented method of claim 79, wherein the channel allocation settings comprise priority allocation settings indicating a priority of one or more audio capture devices.

81. The computer-implemented method of claim 79, wherein the channel allocation settings comprise fixed channel settings indicating a reserved audio channel frequency assignment for one or more audio capture devices.

82. The computer-implemented method of claim 77,
determining a list of preferred audio capture devices, indicating a preference for the preferred audio capture devices on the audio access point transceiver, in accordance with the wireless audio communication profile comprises.

83. The computer-implemented method of claim 77, further comprising:
executing the second pairing validation operation comprising a channel assignment operation, based on a triggering event.

84. The computer-implemented method of claim 83, wherein the triggering event comprises at least one of a pairing event between a pairing audio capture device and the audio access point transceiver, and an unpairing event between an unpairing audio capture device and the audio access point transceiver.

85. The computer-implemented method of claim 84, wherein the pairing event follows the pairing audio capture device being disposed in electrical communication with the audio access point transceiver via a docking port of the audio access point transceiver.

86. The computer-implemented method of claim 84, wherein the pairing event is initiated based on the pairing audio capture device being disposed in a wireless communication proximity to the audio access point transceiver.

87. The computer-implemented method of claim 86, wherein the wireless communication proximity of the pairing audio capture device to the audio access point transceiver is based on a transmission range of a beacon signal.

88. The computer-implemented method of claim 77, wherein the channel assignment operation comprises:
assigning one or more audio capture devices to respective audio channel frequencies based on an audio channel allocation algorithm.

89. The computer-implemented method of claim 88, wherein the audio channel allocation algorithm comprises:
determining an audio channel frequency for an audio capture device based on a historical utilization of one or more audio channel frequencies.

90. The computer-implemented method of claim 88, wherein the audio channel allocation algorithm comprises:
determining an audio channel frequency for an audio capture device based on one or more device status properties of the audio capture device.

91. The computer-implemented method of claim 90, wherein the device status properties of the audio capture device comprise at least one of identity information of the audio capture device, an audio capture device type, an audio capture device role, and a power state of the audio capture device.

92. The computer-implemented method of claim 88, wherein the audio channel allocation algorithm comprises:
adding at least one of the one or more audio capture devices paired to the audio access point transceiver to a waiting queue, wherein the waiting queue comprises audio capture devices paired to the audio access point transceiver awaiting an assigned audio channel frequency.

93. A computer program product, stored on a computer readable medium and comprising instructions that, when executed by one or more processors, cause the one or more processors to:
execute, at a wireless control communication interface, a first pairing validation operation compliant with a first wireless communication protocol,
wherein the first pairing validation operations comprises determining a wireless audio communication profile;
send and receive encrypted wireless audio control signals to and from audio capture devices in accordance with the wireless audio communication profile;
execute, at a wireless audio communication interface, a second pairing validation operation compliant with a second wireless communication protocol,
wherein the second pairing validation operation comprises a channel assignment operation;
send and receive encrypted wireless audio signals to and from audio capture devices in accordance with the channel assignment operation;
distribute, at a wired audio communication interface configured to support one or more wired audio communication protocols, audio signal data to an audio processing network via one or more wired audio communication protocols.

94. The computer program product of claim 93, further configured to cause the one or more processors to:
controlling a distribution of the audio signal data to the audio processing network by a wired control communication interface configured to support one or more wired control communication protocols.

95. The computer program product of claim 93, further configured to cause the one or more processors to:
transmit, by the audio control signals, channel allocation settings to the audio capture devices.

96. The computer program product of claim 93, further comprising:
executing the second pairing validation operation comprising a channel assignment operation, based on a triggering event.

97. The computer program product of claim 93, wherein the channel assignment operation comprises:
assigning one or more audio capture devices to respective audio channel frequencies based on an audio channel allocation algorithm.
